(19) United States
(12) Patent Application Publication
(10) Pub. No.: US 2026/0367836 A1
(43) Pub. Date: Nov. 19, 2026

(54) FUNCTION APPLICABILITY FOR DETERMINATION OF SUPPORTED COMMANDS IN A MEMORY SYSTEM

(71) Applicant: Micron Technology, Inc., Boise, ID (US)

(72) Inventors: John E. Maroney, Irvine, CA (US); Pedro Cordon, Irvine, CA (US); Henry H. Torabi, Irvine, CA (US)

(21) Appl. No.: 19/659,877

(22) Filed: Apr. 27, 2026

Related U.S. Application Data
(60) Provisional application No. 63/806,291, filed on May 15, 2025.

(51) Int. Cl. G06F 3/06

(52) U.S. Cl. CPC G06F 3/0659; G06F 3/0604; G06F 3/0679

(57) ABSTRACT

Methods, systems, and devices for function applicability for determination of supported commands are described. A multi-ported memory system may execute management commands received from host systems according to one or more function applicability rules. The function applicability rules may be applicable to one or more subsets of management commands, including administrative commands, management interface commands, get/set feature commands supported by a management port of the memory system. For example, the function applicability configuration may define a respective function applicability for each command type of a set of management commands supported by the memory system. The function applicability rules may indicate function types permitted to support execution of a given command type. In an example, a function applicability which applies to a first set of commands may indicate that access to the command via an out-of-band interface is restricted.

### CROSS REFERENCE

The present Application for Patent claims priority to U.S. Patent Application No. 63/806,291 by Maroney et al., entitled “FUNCTION APPLICABILITY FOR DETERMINATION OF SUPPORTED COMMANDS IN A MEMORY SYSTEM,” filed May 15, 2025, which is assigned to the assignee hereof, and which is expressly incorporated by reference in its entirety herein.

### TECHNICAL FIELD

The following relates to one or more systems for memory, including function applicability for determination of supported commands.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports function applicability for determination of supported commands in accordance with examples as disclosed herein.

FIG. 2 shows an example of an architecture that supports function applicability for determination of supported commands in accordance with examples as disclosed herein.

FIG. 3 shows an example of a system that supports function applicability for determination of supported commands in accordance with examples as disclosed herein.

FIGS. 4 and 5 show examples of process flows that support function applicability for determination of supported commands in accordance with examples as disclosed herein.

FIG. 6 shows a block diagram of a memory system that supports function applicability for determination of supported commands in accordance with examples as disclosed herein.

FIGS. 7 - 10 show flowcharts illustrating a method or methods that support function applicability for determination of supported commands in accordance with examples as disclosed herein.

### DETAILED DESCRIPTION

Some memory systems may include multiple ports. Each port may include or otherwise be associated with one or more resources (e.g., hardware components, circuitry, or other resources) within the memory system (e.g., on a solid state device (SSD)). Some systems (e.g., automotive systems) may include a single memory system associated with (e.g., coupled with, in communication with) multiple host systems. For example, multiple host systems in a system may access a single multi-ported memory system (e.g., multi-ported SSD). In such an example, each port of the memory system may correspond to a respective physical connection (e.g., host interface) with one or more external host systems. The host systems may communicate with the memory system via the one or more ports and corresponding host interfaces to access data stored within the memory system.

In some examples, one or more host systems may send one or more management commands to the multi-ported memory system, for example via a management port, which may enable modification of administrative settings of the memory system or otherwise enable access to privileged resources. Management commands may include privileged commands, administrative commands, get or set feature commands, or management interface commands, or any combination thereof. A host system may have multiple points of access to the set of management commands based on the memory system being configured with out-of-band and in-band management interfaces (e.g., management ports). For example, a host system may access management commands via dedicated management ports and/or via out-of-band (OOB) signaling (e.g., via a system management bus (SMBus) and/or vendor defined message (VDM)). Definitions and procedures for limiting the access to management commands on a per-interface basis may be beneficial to improve security for multi-port memory systems.

In accordance with examples described herein, the memory system may execute management commands received from one or more host systems according to a function applicability configuration, which may include a set of function applicability rules. The set of function applicability rules may be applicable to one or more subsets of management commands, including administrative commands, management interface commands, or get/set feature commands supported by a management port of the memory system, or any combination thereof. For example, the function applicability configuration may define a respective function applicability for one or more command types, if not each command type, of a set of management commands supported by the memory system. The function applicability rules may indicate function types that are permitted to support execution of a given command type.

In some examples, one or more host systems may send one or more get log page commands to the multi-ported memory system, for example via a management port, which may request access to log information of a given log page stored at the memory system. The log information may indicate one or more operating parameters and/or status information of the memory system over time (e.g., during a course of its operative life). A host system may have multiple points of access to the log pages (e.g., via get log page commands) based on the memory system being configured with out-of-band and in-band management interfaces (e.g., management ports). For example, a host system may access management commands via dedicated management ports and/or via out-of-band (OOB) signaling (e.g., via a system management bus (SMBus) and/or vendor defined message (VDM)). Definitions and procedures for limiting the access to log information stored in log pages on a per-interface basis may be beneficial to improve security for multi-port memory systems.

In accordance with examples described herein, the memory system may grant access to log information from log pages responsive to one or more get log page commands received from one or more host systems according to a function applicability configuration, which may include a set of function applicability rules. For example, the function applicability configuration may define a respective function applicability for one or more log pages, if not each log page, of a set of log pages supported by the memory system. The function applicability rules may indicate function types that are permitted to support access to a given log page.

A function type may refer to whether a command (e.g., get log page command) is received from the host system via (e.g., executed using) a physical function or via a virtual function, or whether the command is received via an OOB interface (e.g., received via SMBus or VDM) or via an in-band interface (e.g., received at an in-band management port), or any combination thereof. In some examples, commands executed via an OOB interface may be elsewhere referred to herein as OOB functions. Commands executed via an in-band interface may be elsewhere referred to herein as physical functions or virtual functions, depending on the function type. The function applicability rules may indicate any combination of physical/virtual functions and in-band/OOB functions as being permitted for access to a corresponding command type or log page to which the function applicability rule applies. For example, a first function applicability which applies to a first set of commands or first set of log pages may indicate that physical functions and virtual functions are permitted for accessing to the command or log page, but OOB functions are excluded from access. A second function applicability which applies to a second set of commands may indicate that physical functions and OOB functions are permitted for accessing to the command or log page, but virtual functions are excluded from access. It is to be understood that other function applicability rules which specify other potential combinations of function or interface types as being supported are also possible, which provides flexibility to the memory system to tailor the level of access to a given management command or group of commands, or to a given log page or group of log pages, among other advantages.

By restricting access to management commands or log page information on a per-interface and/or per-function basis according to the function applicability configurations described herein, a multi-function and/or multi-ported system may have increased security and be less vulnerable to attacks relative to systems with free and unrestricted access to management commands, among other advantages. In some examples, restricting access to resources, privileged commands, or log information at the memory system according to the function applicability rules may enable a management port to function as a root of trust for the memory system. For example, the memory system may support various function types (e.g., physical functions, virtual functions, OOB functions), and the function applicability rules may enable the memory system to grant varying levels of access to features, resources, or log information of the memory system based on the function type used to request the command, which may be based on a perceived level of risk of a given function type compared to other function types, among other potential factors (e.g., based on a functionality, feasibility, or capability of the memory system to support the command or to access the log page via the given function type).

In addition to applicability in memory systems described herein, techniques for function applicability for determination of supported commands may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by restricting access to privileged or management-type commands, specifically tailoring the accessibility of commands on a per-interface basis and a per-function basis. Implementing the techniques described herein may additionally improve the security of electronic devices and systems by restricting access to potentially sensitive or system-critical log information, specifically tailoring the accessibility of log information of log pages on a per-interface basis and a per-function basis. Such techniques to limit the access to commands and to log page information based on the interface or function used may prevent or mitigate unauthorized access to resources or operations, among other benefits. Additionally, the memory system may be implemented within an automotive system (e.g., an automotive SSD), and may thereby support relatively increased security for the automotive system using the function applicability techniques for commands or log pages as described herein.

Features of the disclosure are illustrated and described in the context of systems, devices, and circuits. Features of the disclosure are further illustrated and described in the context of architectures, systems, process flows, block diagrams, and flowcharts.

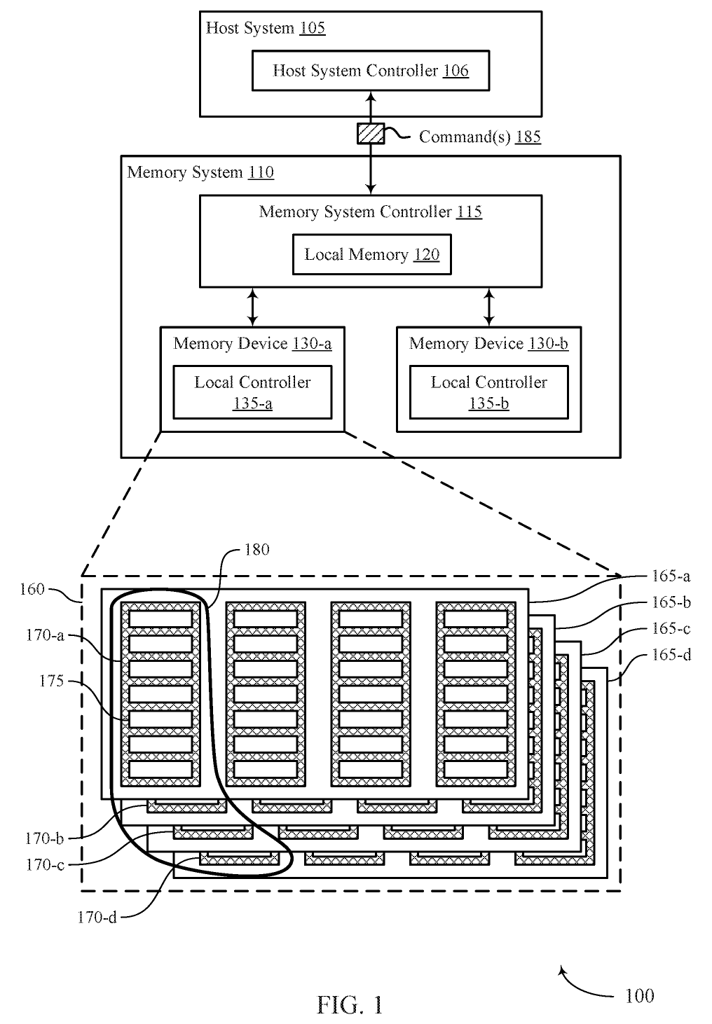

FIG. 1 shows an example of a system 100 that supports function applicability for determination of supported commands in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or any combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the system 100 may support access to various functions within a multi-port memory system as described herein. For example, the memory system 110 may be a multi-port memory system coupled with multiple host systems, where each port may be coupled with one or more of the host systems, including the host system 105. In some cases, the memory system 110 may be coupled with the host system 105 via a trusted port or interface, via which the memory system 110 may receive one or more commands 185. In some cases, the command 185 may define a secure management port, which may be a dedicated port, or may be selected during one or more power-on procedures of the memory system 110. After receiving the command 185, the memory system 110 may use the defined management port to receive and execute additional communications and commands, including commands for resource allocation (e.g., for managing resources), additional configurations, sub-system operations, or diagnostic functions, among other operations.

In accordance with examples described herein, the memory system 110 may execute commands 185 received from host systems 105 according to a function applicability configuration, which may include a set of function applicability rules. The set of function applicability rules may be applicable to one or more subsets of management commands, including administrative commands, management interface commands, or get/set feature commands supported by a management port of the memory system. For example, the function applicability configuration may define a respective function applicability for each command type of a set of commands supported by the memory system 110. The function applicability rules may indicate function types that are permitted to support execution of a given command type.

In some examples, the system 100 may support access to various functions within a multi-port memory system as described herein. For example, the memory system 110 may be a multi-port memory system coupled with multiple host systems, where each port may be coupled with one or more of the host systems, including the host system 105. In some cases, the memory system 110 may be coupled with the host system 105 via a trusted port or interface, via which the memory system 110 may receive one or more commands 185. In some cases, the command 185 may define a secure management port, which may be a dedicated port, or may be selected during one or more power-on procedures of the memory system 110. After receiving the command 185, the memory system 110 may use the defined management port to receive and execute additional communications and commands, including commands for resource allocation (e.g., for managing resources), additional configurations, sub-system operations, or diagnostic functions, among other operations. In some examples, the command 185 may be a get log page command which requests access to information from a log page stored (e.g., and maintained/updated over time) by the memory system 110.

In accordance with examples described herein, the memory system 110 may grant access to log information from log pages responsive to get log page commands received from host systems according to a function applicability configuration, which may include a set of function applicability rules. For example, the function applicability configuration may define a respective function applicability for each log page of a set of log pages supported by the memory system 110. The function applicability rules may indicate function types that are permitted to support access to a given log page.

A function type may refer to whether a command is received from the host system 105 via (e.g., executed using) a physical function or via a virtual function, or whether the command is received via an OOB interface (e.g., interface 235-a, received via SMBus or VDM) or in-band interface (e.g., received at an in-band management such as port 210), or any combination thereof. In some examples, commands executed via an OOB interface may be elsewhere referred to herein as OOB functions. Commands executed via an in-band interface may be elsewhere referred to herein as physical functions or virtual functions, depending on the function type. The function applicability rules may indicate any combination of physical/virtual functions and in-band/OOB functions as being permitted for access to a corresponding command type to which the function applicability rule applies. For example, a first function applicability which applies to a first set of commands may indicate that physical functions and virtual functions are permitted for access to the command, but OOB functions are excluded from access. A second function applicability which applies to a second set of commands may indicate that physical functions and OOB functions are permitted for access to the command, but virtual functions are excluded from access. It is to be understood that other function applicability rules which specify other potential combinations of function or interface types as being supported are also possible, which provides flexibility to the memory system to tailor the level of access to a given management command or group of commands.

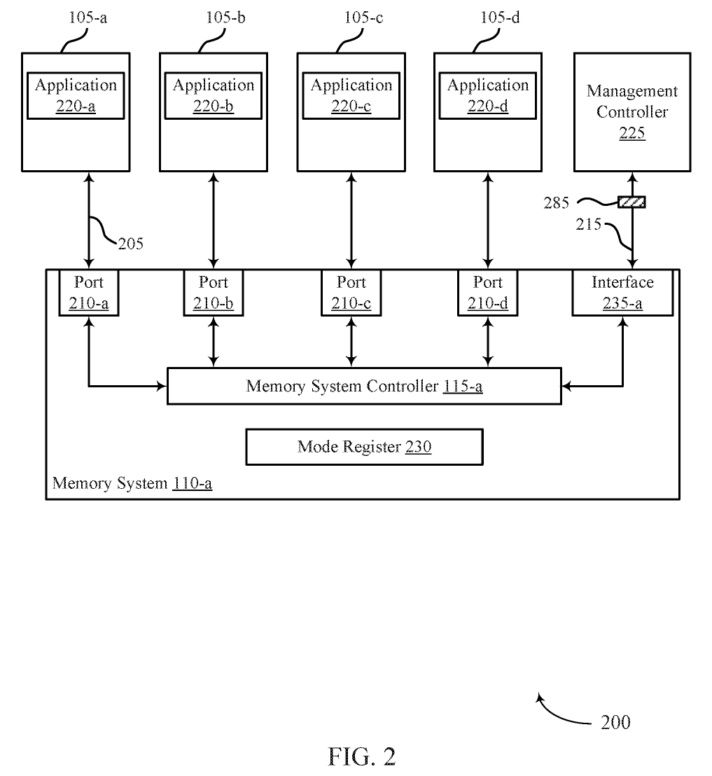

FIG. 2 shows an example of an architecture 200 that supports port resource management within a multi-port memory system in accordance with examples as disclosed herein. One or more aspects of the architecture 200 may implement or may be implemented by one or more aspects of the system 100. For example, the architecture 200 may include a host system 105-a, a host system 105-b, a host system 105-c, a host system 105-d, and a memory system 110-a with a memory system controller 115-a and a mode register 230, which may be examples of corresponding devices or systems described herein. In some cases, the architecture 200 may be implemented in or as part of an automotive system, and the architecture 200 may support increased security by selecting a trusted management port.

For example, memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using data stored to the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. In some examples, each port 210 may operate independently. For example, each port 210 may operate according to different link speeds (e.g., PCIe link speeds) or may be reset independently. Further, the ports 210 may operate simultaneously or concurrently, or at different times. In some cases, boot partitions, replay protected memory blocks (RPMBs), virtualization (e.g., single root I/O virtualization (SRIOV)), and resource allocation may also be configured or otherwise executed per port.

Although the architecture 200 illustrates four host systems 105 and four ports 210, it is to be understood that a memory system 110-a may include any quantity and combination of ports and may be coupled with any quantity and combination of host systems, including four of each, or any other quantities. The memory system 110-a may include one or more memory arrays across one or more memory devices that store data for the execution of the various applications. The ports 210 may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. The host systems 105 may communicate with the memory system 110-a using the ports 210 via in-band signaling (e.g., via a PCIe bus) which may differ from out-of-band (OOB) signaling, as the PCI interface 205 may support transfer of data and commands, while one or more OOB channels may not be used for data transfer, but may instead be used for transfer of metadata and other management commands. Commands sent by a host system 105 may cause or instruct the memory system controller 115-a to execute operations and/or access memory (e.g., at one or more memory devices 130 of the memory system 110-a). The commands may be non-volatile memory express (NVMe) commands, or some other type of command.

Once authenticated with the memory system 110-a, the management controller 225 may (e.g., via the OOB signaling 215) request that any one or more host systems 105 gain access (e.g., privileged access) to a respective port 210 of the memory system 110-a (or such ports may request to be a trusted port). For example, the authentication management controller 225 may transmit one or more commands that request that the host system 105-a gain privileged access to the port 210-a, that the host system 105-b gain privileged access to the port 210-b, and so on.

In some examples, the memory system 110-a may include an interface 235-a (e.g., a management port) which may be used for managing one or more aspects of the memory system 110-a. In some examples, the memory system 110-a may use the interface 235-a for authentication of the host systems 105 prior to the memory system 110-a granting the host systems 105 access to the ports 210. For example, the memory system 110-a may grant a management controller 225 access to the interface 235-a based on an attestation process between the memory system 110-a and the authentication management controller 225. The authentication management controller 225 and the memory system 110-a may perform the attestation process by transmitting OOB signaling 215 via a system channel bus (e.g., an inter-integrated circuit (I2C) bus, a system management bus (SMBus)). Additionally, or alternatively, the OOB signaling 215 may be one or more vendor defined messages that are transmitted via an NVMe management interface (NVMe-MI), or some other interface. In some examples, the management controller 225 may be an example of a separate management controller with a separate management operating system, or may be an example of a combined host processor and management controller. If the management controller 225 is within a host system 105, the management controller 225 may communicate with the interface 235-a (e.g., a port) via an in-band interface, in some examples.

In accordance with examples described herein, the memory system 110-a may further increase security by selecting or determining a port (e.g., a central core or function) for requesting resource changes after attestation. For example, the memory system 110-a may select a trusted port, or function, on a decentralized hub for a security infrastructure that manages security of other ports 210 based on the attestation. In some examples, the memory system 110-a may be configured with a single trusted management port to prevent security breaches from other ports 210. For example, the memory system 110-a may receive a command 285 via a trusted interface or port (e.g., via the interface 235-a, via a trusted port 210) that may indicate the trusted management port. Additionally, or alternatively, the interface 235-a may be the default trusted management port based on the interface 235-a being coupled with the management controller 225 via an OOB connection, or some other port may be a default. In some examples, if the trusted management port is the interface 235-a, the management controller 225 may run a corresponding resource management application.

In some examples, the secure management port may accept commands that are otherwise restricted for other ports 210. For example, the management port (e.g., the interface 235-a, another port 210) may accept vendor defined commands, including commands associated with configuring resources. The management port may also accept commands for setting up virtualization management, namespace configurations, firmware download and commit, among other vendor specific commands associated with user data or firmware. Further, other subsystem operations, such and power management and resets, as well as diagnostic functions, may be accepted and executed by the trusted management port. Such additional operations may be referred to as privileged operations herein. That is, the trusted management port may execute one or more privileged commands. The one or more privileged commands may include get log page command which requests access to information from a log page stored (e.g., and maintained/updated over time) by the memory system 110-a.

In accordance with examples described herein, the memory system 110-a may execute commands (e.g., privileged commands) received from a host system 105 according to a function applicability configuration, which may include a set of function applicability rules (e.g., as designated by an additional function applicability constraint that is different from any constraints defined in the Commands Supported and Effects Log for NVMe or NVMe-MI or Feature Identifiers Standard, among other examples). The set of function applicability rules may be applicable to one or more subsets of management commands, including administrative commands, management interface commands, or get/set feature commands supported by a management port (e.g., a port 210-a, an interface 235-a) of the memory system 110-a. For example, the function applicability configuration may define a respective function applicability for each command type of a set of commands supported by the memory system 110-a. The function applicability rules may indicate function types that are permitted to support execution of a given command type.

Additionally, or alternatively, the memory system 110-a may grant access to log information from log pages responsive to get log page commands received from host systems 105 according to a function applicability configuration, which may include a set of function applicability rules (e.g., a second set of function applicability rules applicable to get log page commands). For example, the function applicability configuration may define a respective function applicability for each log page of a set of log pages supported by the memory system 110-a. The function applicability rules may indicate function types that are permitted to support access to a given log page.

A function type may refer to whether a command is received from a host system 105 via (e.g., executed using) a physical function or via a virtual function, or whether the command is received via an OOB interface (e.g., interface 235-a, received via SMBus or VDM) or in-band interface (e.g., received at an in-band management port such as port 210-a), or any combination thereof. In some examples, commands executed via an OOB interface may be elsewhere referred to herein as OOB functions. Commands executed via an in-band interface may be elsewhere referred to herein as physical functions or virtual functions, depending on the function type. The function applicability rules may indicate any combination of physical/virtual functions and in-band/OOB functions as being permitted for access to a corresponding command type or log page to which the function applicability rule applies. For example, a first function applicability which applies to a first set of commands or first set of log pages may indicate that physical functions and virtual functions are permitted for access to the command or log page, but OOB functions are excluded from access. A second function applicability which applies to a second set of commands or second set of log pages may indicate that physical functions and OOB functions are permitted for access to the command or log page, but virtual functions are excluded from access. It is to be understood that other function applicability rules which specify other potential combinations of function or interface types as being supported are also possible, which provides flexibility to the memory system 110-a to tailor the level of access to a given management command or group of commands or to a given log page or group of log pages.

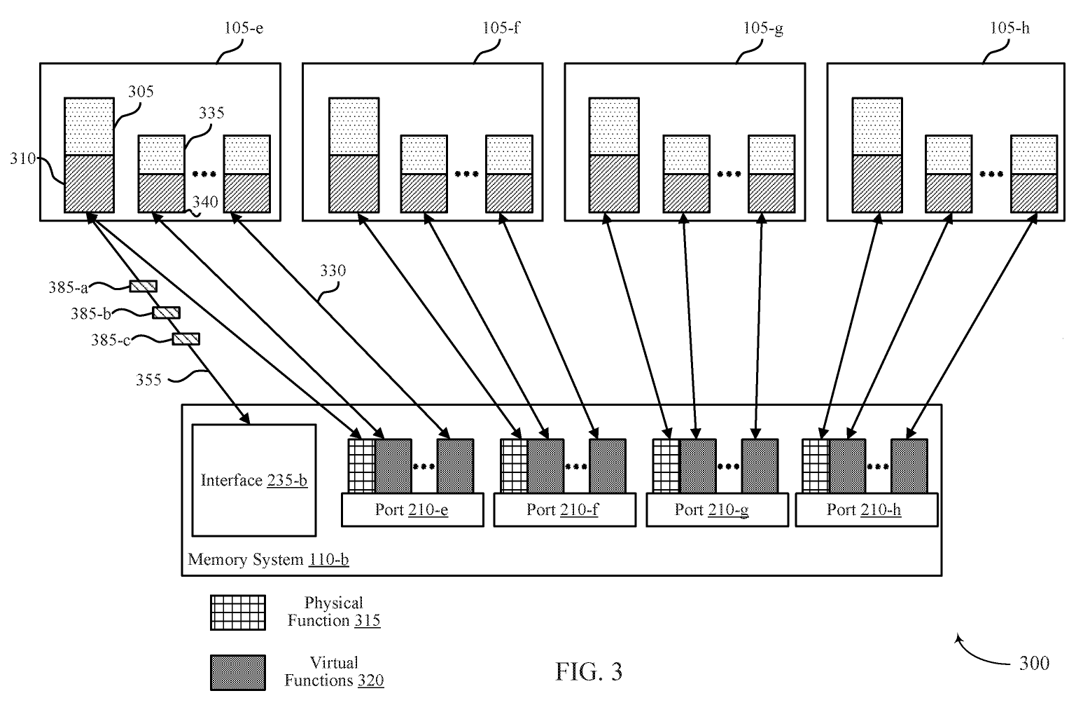

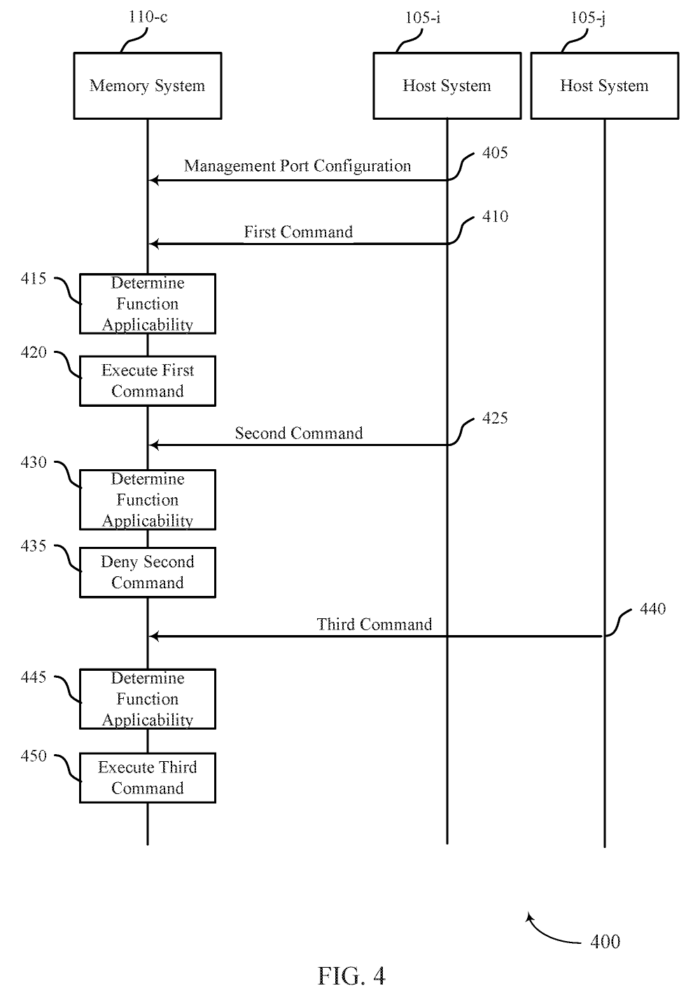

FIG. 3 shows an example of a system 300 that supports port resource management within a multi-port memory system in accordance with examples as disclosed herein. One or more aspects of the system 300 may implement or may be implemented by one or more aspects of the system 100 and the architecture 200. For example, the system 300 may include a memory system 110-b that may be coupled with one or more host systems 105 via one or more ports 210, including host systems 105-e, 105-f, 105-g, and 105-h (e.g., host systems on chips (SOCs)) and ports 210-e, 210-f, 210-g, and 210-h, which may represent examples of the memory systems 110 and 110-a, the host systems 105, and the ports 210, as described with reference to FIGS. 1 and 2. In some examples, the system 300 may support port resource management and other command execution using one or more trusted ports as described herein.

For example, each of the ports 210-e through 210-h may be coupled with a respective management operating system 305 and driver 310 (e.g., an NVMe + NVMe-MI driver) of a respective host system 105. Further, in some cases, the connections may be via a channel 330 of the port and a physical function 315 of the memory system 110-b (e.g., a same physical function shared across all ports), where each port may include one or more respective virtual functions 320. In some examples, each port may involve a different physical function with respective virtual functions 320. Further, each port 210 may include channels 330 that may couple virtual functions 320 with corresponding host operating systems 335 and drivers 340 of the host systems 105-e through 105-h (e.g., via a host interface in accordance with a communication protocol). The memory system 110-b may also include an interface 235-b (e.g., including a management endpoint) coupled with a driver 310 of a management operating system 305 of the host system 105-e (or of a separate management controller) via a channel 355 (e.g., a system management channel, an I2C bus or SMBus). In some examples, the host systems 105 may be controlled by or may include one or more components or systems of an automotive platform and may execute one or more automotive applications.

In some examples, after receiving one or more commands 385-a associated with an attestation of one or more host systems 105 as described herein, the memory system 110-b may receive a command 385-b (e.g., a command for setting ports, referred to as a set-all ports command). The command 385-b may indicate a port 210 as a trusted management port (e.g., resource management port) to support execution of additional commands. In some cases, the indicated port may be a dedicated management port (e.g., a single port trusted for management operations). For example, the command 385-b may indicate the interface 235-b, or may indicate one of the ports 210 as a dedicated management port. Additionally, or alternatively, the management port may be chosen on power up as any of one or more trusted ports 210. For example, if identified as a trusted port during attestation, any of the support ports 210-e through 210-h may be selected and indicated in the command 385-c, even if attestation is first performed using one or more commands 385-a via the interface 235 (e.g., via an SMBus). In some examples, such an indication may overwrite a previously stored trusted management port. In some cases, during attestation, a first port that is selected as trusted may be indicated, or such a selection may rotate among activated ports. Further, while illustrated as received via the interface 235-b, the command 385-b (and 385-a) may be received via any of the channels 330 of the ports 210-e through 210-h.

Additionally, or alternatively, the command 385-b may indicate one or more additional parameters or features, including resources. For example, the command 385-b may indicate a quantity of ports, of multiple ports of the memory system 110-b, to be activated. For example, the command 385-b may indicate a single port, two ports, three ports, up to a total of four ports to be activated (e.g., used by the memory system 110-b or otherwise coupled with external host systems), or any other quantity of ports. The command 385-b may further indicate a trusted computing group (TCG) port, which may be the same as or different from the resource management port, one or more quantities of lanes for each port 210, a density mode, port numbers associated with enabled or disabled virtualization (e.g., single root I/O virtualization (SRIOV) or non-SRIOV), a maximum quantity of virtual functions for each port, a maximum quantity of namespaces (e.g., logical block address (LBA) ranges), a cache type (e.g., whether dynamic cache or volatile write cache is enabled or disabled), among other parameters and values. In some cases, setting a quantity of ports may automatically divide queue resources (e.g., queue pairs, command slots) and interrupt resources evenly across the ports 210-e through 210-h, and may bifurcate PCIe lanes (e.g., corresponding to channels 330) across the activated ports 210. Further, receive and transmit pairs of PCIe with host operating systems 335, reset functions, and maximum virtual functions 320 per port may be configured, including the associations and connections illustrated in FIG. 3.

In some examples, the trusted management port may be used for executing additional commands. For example, the memory system 110-b may receive, at the trusted management port (e.g., via interface 235-b or an indicated port 210), one or more commands 385-c. In some cases, the one or more commands 385-c may be based on the attestation of one or more host systems 105, where at least one command may be to allocate resources of the memory system 110-b to the quantity of ports. For example, one or more commands 385-c may indicate resources, including command slots, queue resources and interrupt resources (e.g., admin related, fixed I/O related, flexible pools allocated via vendor defined command for physical function or virtual functions, etc.), function resources (e.g., virtual functions 320), cache resources, and namespaces, among other resources, for each of the ports 210-e through 210-h. Further, a maximum quantity of resources may be indicated for a function. Other resources or signals may be shared across ports 210 (e.g., CLKREQ across ports, SMBus and SMBus Alert, Power Loss Notification (PLN) and Power Loss Alert (PLA), among other examples). Using the indication of resources, the memory system 110-b may allocate, to each port 210, a respective set of resources. After allocating the resources, the memory system 110-b may receive and execute respective access commands for each active port 210.

The trusted management port may further be used to execute additional commands that may otherwise be restricted at other ports (e.g., may be dedicatedly performed at the trusted port). For example, the management port may support execution of commands 385-c (e.g., via a corresponding physical function 315) associated with accessing user data or firmware of the memory system 110-b. Such commands may be, for example, associated with setting one or more values for or performing one or more data or firmware operations, among other operations involving the memory system 110-b or other components of the system 300 (e.g., setting power management, temperature threshold, error recovery, volatile write cache, autonomous power state transition, host controlled thermal management, non-operational power state configuration, host behavior support, namespace management, firmware commit or image download, device self-test, namespace attachment, virtualization management, clock management, NVMe-MI send or receive, capacity management or managing endurance groups, sanitize, among other commands).

Additionally, or alternatively, the management port may support execution of commands 385-c that may be sub-system operation commands 385-c, including power management commands and reset commands (e.g., resets for NVM subsystems, functions, PCIe and PCIe link, and controllers, among other systems), among other privileged commands. In some examples, reset commands may be per physical function 315, per virtual function 320, or for both, and may involve disable or reset of one or more virtual functions. The first port may also support execution of diagnostic commands, where at least a command 385-c may be a diagnostic command (e.g., self-test, safety mechanism check, error injection, loopback test, authentication, among other diagnostic commands). In some examples, other non-selected ports 210 may not be trusted, and may restrict execution of commands 385-c in accordance with one or more communication protocols (e.g., may respond with a path related status or controller path error).

In some examples, utilizing the commands 385-a, 385-b, and 385-c may thus support configuration of and use of a single management port for resource management and for communication of additional commands. By using a single management port (e.g., the interface 235-b or one of the ports 210-e through 210-f) for resource management or communication of other commands involving user data, firmware, or diagnostics (e.g., the one or more commands 385-c), the memory system 110-b may have increased security and be less vulnerable to attacks than systems in which multiple ports are able to manage resource allocation. Additionally, utilizing a command indicating a trusted port (e.g., the command 385-b), among other commands, may support changing of a management port based on one or more factors (e.g., based on a module upgrade to a more secure host), increasing flexibility of system configurations. The memory system 110-b may, in some cases, represent an example of or otherwise be included within an automotive system (e.g., an automotive SSD) or another type of system associated with relatively high reliability and security requirements. The techniques described herein for port resource management within the multi-port memory system 110-b may improve security and data integrity within the automotive system, thereby increasing user experience and mitigating risks from security attacks, among other examples. For example, one or more of the host systems 105-e through 105-h (e.g., functions, applications) may be less susceptible to attack or hacks than other host systems 105, and may be designated as management host system(s) to be coupled with management port(s), improving security and reliability of the resource management and allocation functions within the automotive system.

In accordance with examples described herein, the memory system 110-b may execute commands received from a host system 105 according to a function applicability configuration, which may include a set of function applicability rules. The set of function applicability rules may be applicable to one or more subsets of management commands, including administrative commands, management interface commands, or get/set feature commands supported by a management port (e.g., a port 210-e, an interface 235-b) of the memory system 110-b. For example, the function applicability configuration may define a respective function applicability for each command type of a set of commands supported by the memory system 110. The function applicability rules may indicate function types that are permitted to support execution of a given command type.

Additionally, or alternatively, the memory system 110-b may grant access to log information from log pages responsive to get log page commands received from host systems 105 according to a function applicability configuration, which may include a set of function applicability rules. For example, the function applicability configuration may define a respective function applicability for each log page of a set of log pages supported by a management port (e.g., a port 210-e, an interface 235-b). The function applicability rules may indicate function types that are permitted to support access to a given log page.

A function type may refer to whether a command is received from a host system 105 via (e.g., executed using) a physical function or via a virtual function, or whether the command is received via an OOB interface (e.g., interface 235-b, received via a channel 355 such as SMBus or VDM) or in-band interface (e.g., received at an in-band management port such as port 210-e), or any combination thereof. In some examples, commands executed via an OOB interface may be elsewhere referred to herein as OOB functions. Commands executed via an in-band interface may be elsewhere referred to herein as physical functions or virtual functions, depending on the function type. The function applicability rules may indicate any combination of physical/virtual functions and in-band/OOB functions as being permitted for access to a corresponding command type or log page to which the function applicability rule applies. For example, a first function applicability which applies to a first set of commands or first set of log pages may indicate that physical functions and virtual functions are permitted for access to the command or log page, but OOB functions are excluded from access. A second function applicability which applies to a second set of commands or second set of log pages may indicate that physical functions and OOB functions are permitted for access to the command or log page, but virtual functions are excluded from access. It is to be understood that other function applicability rules which specify other potential combinations of function or interface types as being supported are also possible, which provides flexibility to the memory system 110-b to tailor the level of access to a given management command or group of commands to a given log page or group of log pages.

FIG. 4 shows an example of a process flow 400 that supports function applicability for determination of supported commands in accordance with examples as disclosed herein. The process flow 400 may implement or may be implemented by aspects of the system 100 or the architecture 200. For example, the process flow 400 may include a memory system 110-c, a host system 105-i, and host system 105-j, which may be examples of corresponding devices described herein. The process flow 400 is depicted to start at 405 and end at 450, but may include additional operations (not shown), or operations may be omitted, modified, or performed in a different order in accordance with the described techniques. In some examples, the host systems 105 may be controlled by or may include one or more components or systems of an automotive platform and may execute one or more automotive applications.

At 405, the memory system 110-c may receive a management port configuration from the host system 105-i via a first host interface. The first host interface may be an OOB interface (e.g., an interface 235-b, a channel 355, SMBus or VDM), which may be elsewhere referred to herein as an OOB management port. The management port configuration may indicate that the host system 105-j is configured as a management port (e.g., a trusted management port) for the memory system 110-c. The host system 105-j may be coupled with the memory system 110-c via a second host interface. The second host interface may be an in-band interface (e.g., a PCI interface 205, a channel 330) and may support physical functions 315, virtual functions 320, or both. The second host interface may be elsewhere referred to herein as an in-band management port. In some examples, the OOB management port (e.g., SMBus or VDM) may be available to one or more host systems as a default (e.g., without prior configuration), whereas one or more in-band management ports may be established at the memory system 110-c based on the management port configuration (e.g., via OOB signaling, according to a set all ports command or a predefined management port strategy, or both).

In some examples, the management port configuration may indicate or be associated with a function applicability configuration of the memory system 110-c which includes a set of function applicability rules. The set of function applicability rules may be applicable to one or more subsets of commands, including NVMe administrative commands, NVME-MI commands, or get/set feature commands supported by a management port (e.g., an in-band management port or OOB management port) of the memory system 110-c. For example, the function applicability configuration may define a respective function applicability for each command type of the one or more subsets of commands. The function applicability rules may indicate function types that are permitted to support execution of a given command type. A function type may refer to whether a command is received via (e.g., executed using) a physical function or via a virtual function, or whether the command is received via an OOB interface (e.g., received at an OOB management port) or in-band interface (e.g., received at an in-band management port), or any combination thereof. In some examples, commands executed via an OOB interface may be elsewhere referred to herein as OOB functions. Commands executed via an in-band interface may be elsewhere referred to herein as physical functions or virtual functions, depending on the function type that is used.

For example, a first function applicability rule for a first command type (e.g., identify commands) may indicate that all functions (e.g., inclusive of physical functions, virtual functions, and OOB functions) are permitted to support execution of commands of the first command type. Additionally, or alternatively, a second function applicability rule for a second command type (e.g., create I/O submission queue commands) may indicate that commands of the second command type are disallowed on the OOB interface or that a set of functions supporting execution of the second command type excludes OOB functions. Additionally, or alternatively, a third function applicability rule for a third command type (e.g., namespace management commands) may indicate that commands of the third command type are disallowed for virtual functions or that a set of functions supporting execution of the third command type excludes virtual functions. It is to be understood that the function applicability rules described herein are not limiting, and function applicability rules may indicate any possible combinations of physical/virtual functions and in-band/OOB functions as being permitted for access to a corresponding command type to which the function applicability rule applies.

At 410, the memory system 110-c may receive a first command. The memory system 110-c may receive the first command from the host system 105-i via an OOB interface. At 415, the memory system 110-c may determine a first function applicability for the first command based on the function applicability configuration. In some examples, the first function applicability may indicate that both physical functions via an in-band interface and all functions via an OOB interface are permitted to support execution of the first command. At 420, the memory system 110-c may execute the first command based on the first command being received via the OOB interface and based on the first function applicability indicating that functions via an OOB interface are supported for execution of the first command.

At 425, the memory system 110-c may receive a second command. The memory system 110-c may receive the second command from the host system 105-i via an OOB interface. At 430, the memory system 110-c may determine a second function applicability for the second command based on the function applicability configuration. The second function applicability may be different from the first function applicability (e.g., and may indicate that a second, different set of functions support execution of the second command relative to functions which support the first command). In some examples, the second function applicability may indicate that functions (e.g., both physical functions and virtual functions) via an in-band interface are permitted to support execution of the second command but that OOB functions are excluded. At 435, the memory system 110-c may refrain from executing the second command based on the second command being received via the OOB interface and based on the second function applicability indicating that functions via an OOB interface are not supported (e.g., are excluded) for execution of the second command.

At 440, the memory system 110-c may receive a third command. The memory system 110-c may receive the third command from the host system 105-j via an in-band interface. At 445, the memory system 110-c may determine a third function applicability for the third command based on the function applicability configuration. The third function applicability may be different from the first and second function applicability (e.g., and may indicate that a third, different set of functions support execution of the third command relative to respective sets of functions for the first and second command). In some examples, the third function applicability may indicate that physical functions via an in-band interface and OOB functions are permitted to support execution of the third command and/or that virtual functions via the in-band interface are not supported (e.g., are excluded) for execution of the third command.

In some examples, at 440, the memory system 110-c may receive the third command via a physical function on the in-band interface. In such examples, at 450, the memory system 110-c may execute the third command based on the third command being received via the physical function and based on the third function applicability indicating that physical functions are supported for execution of the third command. In some other examples, the memory system 110-c may receive the third command via a virtual function on the in-band interface. In such examples, the memory system 110-c may refrain from executing the third command based on the third command being received via the virtual function and based on the third function applicability indicating that virtual functions are not supported (e.g., excluded) for execution of the third command. In some examples, a function applicability may include a function type (e.g., a virtual function type) as being supported for a given command type for compliance reasons but may have no bearing on whether the memory system 110-c is responsive to the command (e.g., takes any action on the command). As an illustrative example, a function applicability for power management commands, LBA range type commands, and temperature threshold commands may indicate that virtual functions are permitted for the command, but such commands may result in any effect or outcome (e.g., no action taken by the memory system 110-c) when received via virtual functions.

In accordance with these and other examples, the memory system 110-c, which may include a multi-ported memory device, may restrict access to commands on a per-interface and/or per-function basis to enhance the security of the memory system 110-c. In some examples, restricting access to resources or privileged commands at the memory system 110-c according to the function applicability rules may enable a management port to function as a root of trust for the memory system 110-c. For example, the memory system 110-c may support various function types (e.g., physical functions, virtual functions, OOB functions), and the function applicability rules may enable the memory system 110-c to grant varying levels of access to features or resources of the memory system 110-c based on the function type used to request the command, which may be based on a perceived level of risk of a given function type compared to other function types, among other potential factors (e.g., based on a functionality, feasibility, or capability of the memory system 110-c to support the command via the given function type).

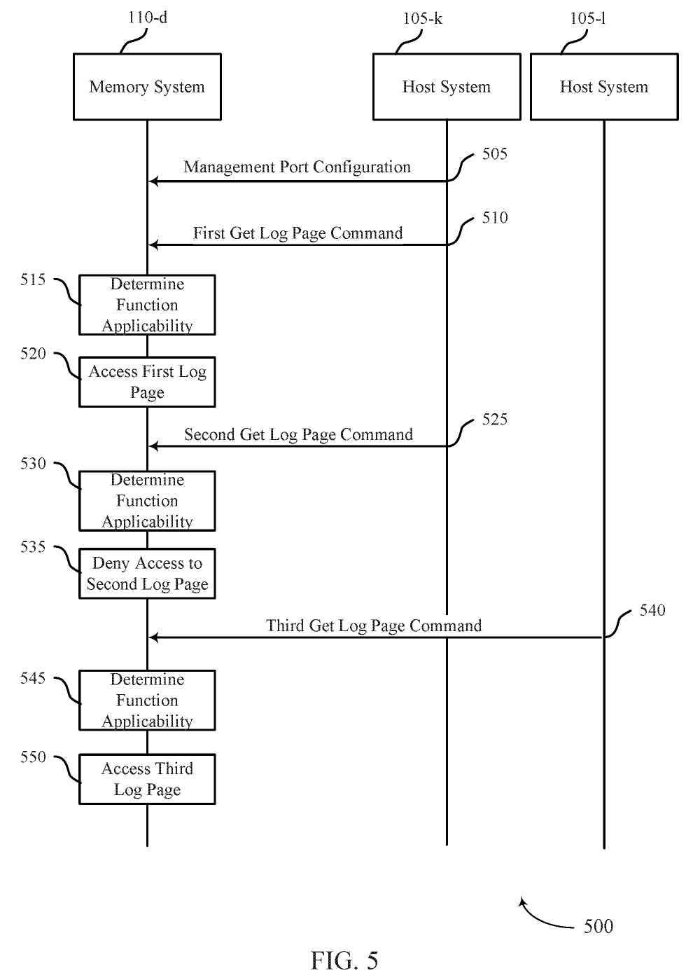

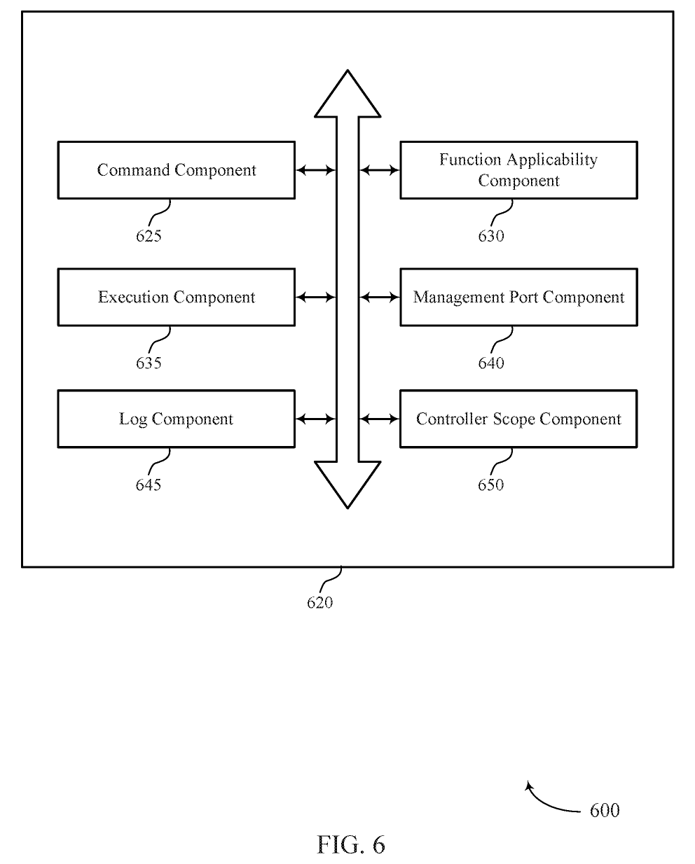

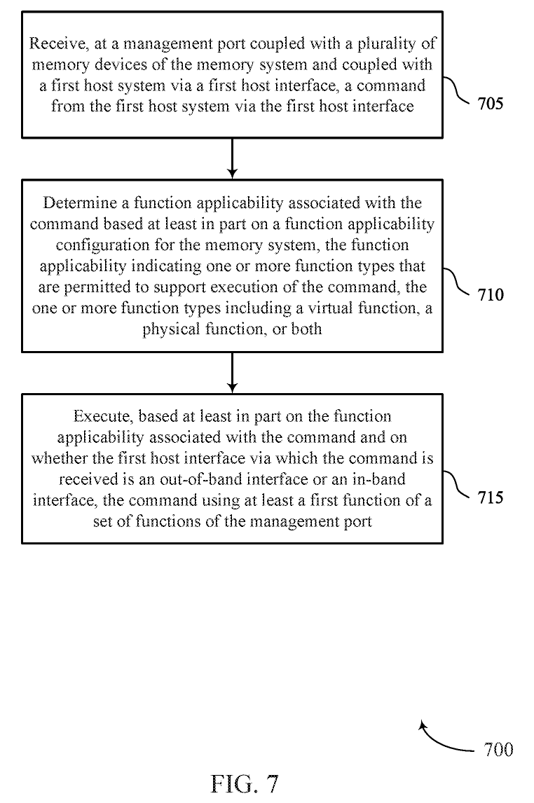

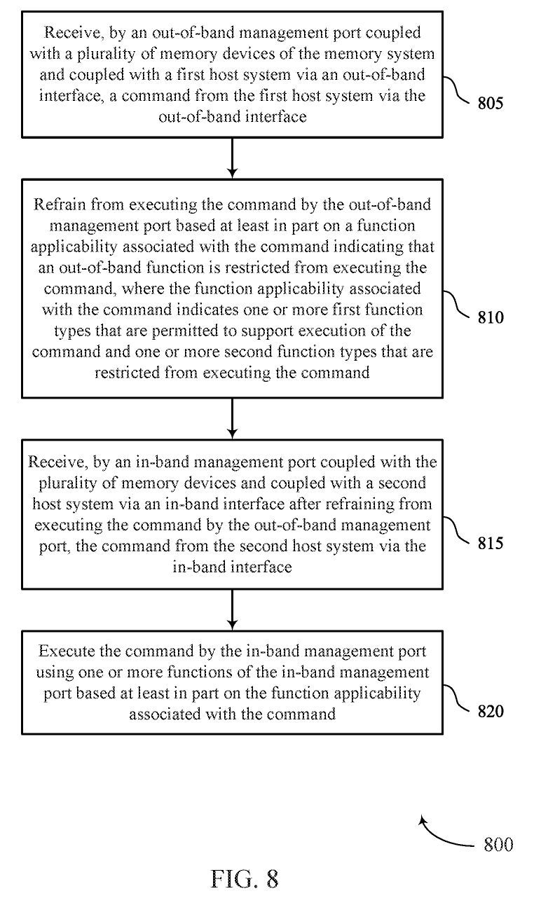

FIG. 5 shows an example of a process flow 500 that supports function applicability for determination of supported commands in accordance with examples as disclosed herein. The process flow 500 may implement or may be implemented by aspects of the system 100 or the architecture 200. For example, the process flow 500 may include a memory system 110-d, a host system 105-k, and host system 105-l, which may be examples of corresponding devices described herein. The process flow 500 is depicted to start at 505 and end at 550, but may include additional operations (not shown), or operations may be omitted, modified, or performed in a different order in accordance with the described techniques. In some examples, the host systems 105 may be controlled by or may include one or more components or systems of an automotive platform and may execute one or more automotive applications.

At 505, the memory system 110-d may receive a management port configuration from the host system 105-k via a first host interface. The first host interface may be an OOB interface (e.g., an interface 235-b, a channel 355, SMBus or VDM), which may be elsewhere referred to herein as an OOB management port. The management port configuration may indicate that the host system 105-l is configured as a management port (e.g., a trusted management port) for the memory system 110-d. The host system 105-l may be coupled with the memory system 110-d via a second host interface. The second host interface may be an in-band interface (e.g., a PCI interface 205, a channel 330) and may support physical functions 315, virtual functions 320, or both. The second host interface may be elsewhere referred to herein as an in-band management port. In some examples, the OOB management port (e.g., SMBus or VDM) may be available to one or more host systems as a default (e.g., without prior configuration), whereas one or more in-band management ports may be established at the memory system 110-d based on the management port configuration (e.g., via OOB signaling, according to a set all ports command or a predefined management port strategy, or both).

In some examples, the management port configuration may indicate or be associated with a function applicability configuration of the memory system 110-d which includes a set of function applicability rules. The set of function applicability rules may be applicable to one or more log pages of the memory system 110-d. For example, the function applicability configuration may define a respective function applicability for each log page of a set of log pages stored at the memory system 110-d. The function applicability rules may indicate function types that are permitted to support execution of get log page commands directed to a given log page. A function type may refer to whether a get log page command is received via (e.g., executed using) a physical function or via a virtual function, or whether the get log page command is received via an OOB interface (e.g., received at an OOB management port) or in-band interface (e.g., received at an in-band management port), or any combination thereof. In some examples, get log page commands executed via an OOB interface may be elsewhere referred to herein as OOB functions. Get log page commands executed via an in-band interface may be elsewhere referred to herein as physical functions or virtual functions, depending on the function type that is used.

A first function applicability rule for a first log page (e.g., error information) may indicate that all functions (e.g., inclusive of physical functions, virtual functions, and OOB functions) are permitted to support access to information of the first log page (e.g., permitted to execute get log page commands for the first log page). Additionally, or alternatively, a second function applicability rule for a second log page (e.g., media unit status) may indicate that the second log page is disallowed from being accessed via virtual functions or that a set of functions supporting access to the second log page excludes virtual functions. Additionally, or alternatively, a third function applicability rule for a third log page (e.g., LBA status information) may indicate that access to the third log page is restricted for all functions (e.g., not accessible, irrespective of function type). It is to be understood that the function applicability rules described herein are not limiting, and function applicability rules may indicate any possible combinations of physical/virtual functions and in-band/OOB functions as being permitted for access to a corresponding log page to which the function applicability rule applies.

In some examples, a set of controller scope rules for a set of log pages stored at the memory system 110-d may be defined. For example, the controller scope rules may be indicated via the function applicability configuration, the management port configuration, or both. The controller scope rules may indicate that the log information in a given log page that is accessible via a management port corresponds to a first subset of controllers of the memory system (e.g., that a subset of information from the log page is available for access). For example, a controller scope rule for a log page may indicate a respective namespace identifier corresponding to log information at the log page which is accessible by the get log page command (e.g., and other log information stored at the log page may be inaccessible by get log page commands).

In some examples, though the memory system may store log information for controllers outside of the specified controller scope, the memory system 110-d may limit access to only a subset of the log information for a given log page such that the log information accessible to the host system via the management port is according to (e.g., matches) the controller scope indicated by the controller scope rules. The controller scope rules may specify that access to log information of a given log page is applicable to operating/status information at a controller-level (e.g., a first level of access), is applicable to operating/status information at a NVM subsystem-level (e.g., a second level of access greater than the first level of access), or is applicable to operating/status information of a particular namespace (e.g., a third level of access) of the memory system 110-d. Each level of access to the log page granted according to the indicated controller scope may correspond to a respective subset of log information from the log page.

At 510, the memory system 110-d may receive a first get log page command requesting to access a first log page. The memory system 110-d may receive the first get log page command from the host system 105-k via an OOB interface. At 515, the memory system 110-d may determine a first function applicability for the first log page based on the function applicability configuration. In some examples, the first function applicability may indicate that both physical and virtual functions via an in-band interface and functions via an OOB interface are permitted to access the first log page. At 520, the memory system 110-d may access the log information from the first log page based on the first get log page command being received via the OOB interface and based on the first function applicability indicating that functions via an OOB interface are supported for access to the first log page.

At 525, the memory system 110-d may receive a second get log page command requesting to access a second log page. The memory system 110-d may receive the second get log page command from the host system 105-k via an OOB interface. At 530, the memory system 110-d may determine a second function applicability for the second log page based on the function applicability configuration. The second function applicability may be different from the first function applicability (e.g., and may indicate that a second, different set of functions support access to the second log page relative to functions which support access to the first log page). In some examples, the second function applicability may indicate that functions (e.g., both physical functions and virtual functions) via an in-band interface are permitted to support access to the second log page but that OOB functions are excluded. At 535, the memory system 110-d may refrain from accessing log information from the second log page based on the second get log page command being received via the OOB interface and based on the second function applicability indicating that functions via an OOB interface are not supported (e.g., are excluded) for access to the second log page.

At 540, the memory system 110-d may receive a third get log page command requesting access to a third log page. The memory system 110-d may receive the third command from the host system 105-l via an in-band interface. At 545, the memory system 110-d may determine a third function applicability for the third command based on the function applicability configuration. The third function applicability may be different from the first and second function applicability (e.g., and may indicate that a third, different set of functions support access to the third log page relative to respective sets of functions for the first and second log pages). In some examples, the third function applicability may indicate that physical functions via an in-band interface and OOB functions are permitted to support execution of the third command and/or that virtual functions via the in-band interface are not supported (e.g., are excluded) for execution of the third command.

In some examples, at 540, the memory system 110-d may receive the third get log page command via a physical function on the in-band interface. In such examples, at 550, the memory system 110-d may execute the third get log page command to access log information of the third log page based on the third command being received via the physical function and based on the third function applicability indicating that physical functions are supported for access to the third log page. In some other examples, the memory system 110-d may receive the third get log page command via a virtual function on the in-band interface. In such examples, the memory system 110-d may refrain from accessing log information of the third log page based on the third command being received via the virtual function and based on the third function applicability indicating that virtual functions are not supported (e.g., excluded) for access to the third log page.

In accordance with these and other examples, the memory system 110-d, which may include a multi-ported memory device, may restrict access to log pages on a per-interface and/or per-function basis to enhance the security of the memory system 110-d. In some examples, restricting access to log pages at the memory system 110-d according to the function applicability rules may enable a management port to function as a root of trust for the memory system 110-d. For example, the memory system 110-d may support various function types (e.g., physical functions, virtual functions, OOB functions), and the function applicability rules may enable the memory system 110-d to grant varying levels of access to log pages of the memory system 110-d based on the function type used to request the log page, which may be based on a perceived level of risk of a given function type compared to other function types, among other potential factors (e.g., based on a functionality, feasibility, or capability of the memory system 110-d to support access to the log page via the given function type).

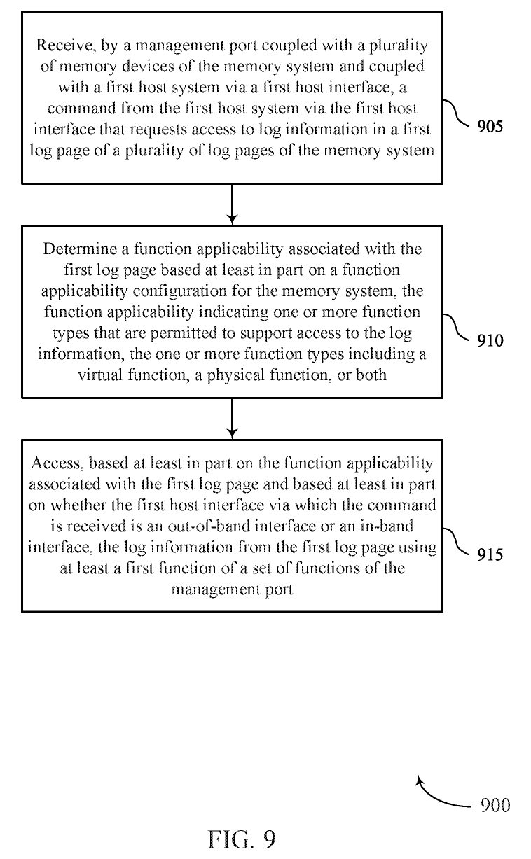

FIG. 6 shows a block diagram 600 of a memory system 620 that supports function applicability for determination of supported commands in accordance with examples as disclosed herein. The memory system 620 may be an example of aspects of a memory system as described with reference to FIGS. 1 - 4. The memory system 620, or various components thereof, may be an example of means for performing various aspects of function applicability for determination of supported commands as described herein. For example, the memory system 620 may include a command component 625, a function applicability component 630, an execution component 635, a management port component 640, a log component 645, a controller scope component 650, or any combination thereof. Each of these components, or components of subcomponents thereof (e.g., one or more processors, one or more memories), may communicate, directly or indirectly, with one another (e.g., via one or more buses).

The command component 625 may be configured as or otherwise support a means for receiving, at a management port coupled with a plurality of memory devices of the memory system and coupled with a first host system via a first host interface, a command from the first host system via the first host interface. The function applicability component 630 may be configured as or otherwise support a means for determining a function applicability associated with the command based at least in part on a function applicability configuration for the memory system, the function applicability indicating one or more function types that are permitted to support execution of the command, the one or more function types including a virtual function, a physical function, or both. The execution component 635 may be configured as or otherwise support a means for executing, based at least in part on the function applicability associated with the command and on whether the first host interface via which the command is received is an out-of-band interface or an in-band interface, the command using at least a first function of a set of functions of the management port.

In some examples, to support determining the function applicability associated with the command, the function applicability component 630 may be configured as or otherwise support a means for determining that the one or more function types that are permitted to support execution of the command include in-band functions, out-of-band functions, or both.

In some examples, to support, determining the function applicability associated with the command, the function applicability component 630 may be configured as or otherwise support a means for determining that the one or more function types that are permitted to support execution of the command include virtual functions, physical functions, or both.

In some examples, the function applicability configuration indicates a respective function applicability for each command of a plurality of commands supported by the management port.

In some examples, the command component 625 may be configured as or otherwise support a means for receiving, at the management port, a second command from the first host system via the first host interface. In some examples, the function applicability component 630 may be configured as or otherwise support a means for determining a second function applicability associated with the second command based at least in part on the function applicability configuration, where the second function applicability indicates one or more second function types that are permitted to support execution of the second command, the one or more second function types being different from the one or more function types associated with the function applicability of the command.

In some examples, the one or more second function types associated with the second function applicability exclude out-of-band functions.

In some examples, the execution component 635 may be configured as or otherwise support a means for refraining from executing the second command based at least in part on the second function applicability indicating that the one or more second function types that are permitted to support execution of the second command exclude out-of-band functions and based at least in part on the first host interface via which the second command is received being the out-of-band interface.

In some examples, the out-of-band interface includes a system management bus. In some examples, the out-of-band interface includes a management interface configured to support one or more vendor defined messages. In some examples, the command includes an administrative command, a get or set feature command, a management interface command, or any combination thereof.

In some examples, the management port is coupled with the first host system via the out-of-band interface, and the command component 625 may be configured as or otherwise support a means for receiving, at a second management port coupled with the plurality of memory devices and coupled with a second host system via a second interface that is the in-band interface, a plurality of second commands via the in-band interface. In some examples, the management port is coupled with the first host system via the out-of-band interface, and the function applicability component 630 may be configured as or otherwise support a means for determining whether to execute the plurality of second commands based at least in part on respective function applicability information for the plurality of second commands.

In some examples, the command component 625 may be configured as or otherwise support a means for receiving, by an out-of-band management port coupled with a plurality of memory devices of the memory system and coupled with a first host system via an out-of-band interface, a command from the first host system via the out-of-band interface. In some examples, the execution component 635 may be configured as or otherwise support a means for refraining from executing the command by the out-of-band management port based at least in part on a function applicability associated with the command indicating that an out-of-band function is restricted from executing the command, where the function applicability associated with the command indicates one or more first function types that are permitted to support execution of the command and one or more second function types that are restricted from executing the command. In some examples, the command component 625 may be configured as or otherwise support a means for receiving, by an in-band management port coupled with the plurality of memory devices and coupled with a second host system via an in-band interface after refraining from executing the command by the out-of-band management port, the command from the second host system via the in-band interface. In some examples, the execution component 635 may be configured as or otherwise support a means for executing the command by the in-band management port using one or more functions of the in-band management port based at least in part on the function applicability associated with the command.

In some examples, the management port component 640 may be configured as or otherwise support a means for receiving, by the out-of-band management port, a management port configuration that indicates the in-band management port from a plurality of ports of the memory system and indicates a function applicability configuration for the memory system, where executing the command by the in-band management port is based at least in part on receiving the management port configuration.

In some examples, the function applicability associated with the command is based at least in part on a function applicability configuration that indicates a respective function applicability for each command of a plurality of commands supported by the memory system.

In some examples, the out-of-band interface includes a system management bus. In some examples, the out-of-band interface includes a management interface configured to support one or more vendor defined messages. In some examples, the command includes an administrative command, a get or set feature command, a management interface command, or any combination thereof.

The command component 625 may be configured as or otherwise support a means for receiving, by a management port coupled with a plurality of memory devices of the memory system and coupled with a first host system via a first host interface, a command from the first host system via the first host interface that requests access to log information in a first log page of a plurality of log pages of the memory system. The function applicability component 630 may be configured as or otherwise support a means for determining a function applicability associated with the first log page based at least in part on a function applicability configuration for the memory system, the function applicability indicating one or more function types that are permitted to support access to the log information, the one or more function types including a virtual function, a physical function, or both. The log component 645 may be configured as or otherwise support a means for accessing, based at least in part on the function applicability associated with the first log page and based at least in part on whether the first host interface via which the command is received is an out-of-band interface or an in-band interface, the log information from the first log page using at least a first function of a set of functions of the management port.

In some examples, the controller scope component 650 may be configured as or otherwise support a means for determining a controller scope associated with the first log page based at least in part on a controller scope configuration for the memory system, the controller scope indicating that the log information in the first log page corresponds to a first subset of controllers of the memory system, where access to the log information is further based at least in part on the controller scope associated with the first log page.

In some examples, the controller scope configuration includes a namespace identifier indicating the controller scope associated with the first log page.

In some examples, to support determining the function applicability associated with the first log page, the function applicability component 630 may be configured as or otherwise support a means for determining that the one or more function types that are permitted to support access to the log information in the first log page include in-band functions, out-of-band functions, or both.

In some examples, to support determining the function applicability associated with the first log page, the function applicability component 630 may be configured as or otherwise support a means for determining that the one or more function types that are permitted to support access to the log information in the first log page include virtual functions, physical functions, or both.

In some examples, the function applicability configuration indicates a respective function applicability and a respective controller scope for each log page of the plurality of log pages of the memory system.

In some examples, the command component 625 may be configured as or otherwise support a means for receiving, from the first host system via the first host interface, a second command that requests access to second log information in a second log page of the plurality of log pages of the memory system. In some examples, the function applicability component 630 may be configured as or otherwise support a means for determining a second function applicability associated with the second log page based at least in part on the function applicability configuration, where the second function applicability indicates one or more second function types that are permitted to support access of the second log page, the one or more second function types being different from the one or more function types associated with the function applicability of the first log page.

In some examples, the one or more second function types associated with the second function applicability exclude virtual functions.

In some examples, the log component 645 may be configured as or otherwise support a means for refraining from accessing the second log information in the second log page based at least in part on the second function applicability indicating that the one or more second function types that are permitted to support access of the second log page exclude virtual functions and based at least in part on the second command being received via the virtual function.

In some examples, the out-of-band interface includes a system management bus. In some examples, the out-of-band interface includes a management interface configured to support one or more vendor defined messages.

In some examples, the management port is coupled with the first host system via the out-of-band interface, and the command component 625 may be configured as or otherwise support a means for receiving, by a second management port coupled with the plurality of memory devices and coupled with a second host system via a second interface that is the in-band interface, a plurality of second commands that request access to respective log information in a plurality of second log pages of the plurality of log pages of the memory system. In some examples, the management port is coupled with the first host system via the out-of-band interface, and the function applicability component 630 may be configured as or otherwise support a means for determining whether to access the respective log information in each log page of the plurality of second log pages based at least in part on a respective function applicability for each log page of the plurality of second log pages.

In some examples, the command component 625 may be configured as or otherwise support a means for receiving, by an in-band management port coupled with a plurality of memory devices of the memory system and coupled with a first host system via an in-band interface, a command from the first host system via the in-band interface that requests access to log information in a first log page of a plurality of log pages of the memory system. In some examples, the log component 645 may be configured as or otherwise support a means for refraining from accessing the log information in the first log page by the in-band management port based at least in part on a function applicability associated with the first log page indicating that an in-band function is restricted from accessing the first log page, where the function applicability associated with the first log page indicates one or more first function types that are permitted to access the first log page and one or more second function types that are restricted from accessing the first log page. In some examples, the command component 625 may be configured as or otherwise support a means for receiving, by an out-of-band management port coupled with the plurality of memory devices and coupled with a second host system via an out-of-band interface after refraining from accessing the log information by the in-band management port, the command from the second host system via the out-of-band interface.

In some examples, the log component 645 may be configured as or otherwise support a means for accessing, by the out-of-band management port, the log information at the first log page using one or more functions of the out-of-band management port based at least in part on the function applicability associated with the first log page and on the command being received via the out-of-band interface.

In some examples, refraining from accessing the log information in the first log page by the in-band management port is further based at least in part on receiving the command via a virtual function and the function applicability associated with the first log page indicating that the virtual function is restricted from accessing the first log page.

In some examples, the log component 645 may be configured as or otherwise support a means for receiving, by the out-of-band management port, a management port configuration that indicates the in-band management port from a plurality of ports of the memory system and indicates a function applicability configuration for the memory system, where refraining from accessing the log information in the first log page by the in-band management port is based at least in part on receiving the management port configuration.

In some examples, the function applicability associated with the first log page is based at least in part on a function applicability configuration that indicates a respective function applicability for each log page of the plurality of log pages of the memory system.

In some examples, the out-of-band interface includes a system management bus. In some examples, the out-of-band interface includes a management interface configured to support one or more vendor defined messages.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

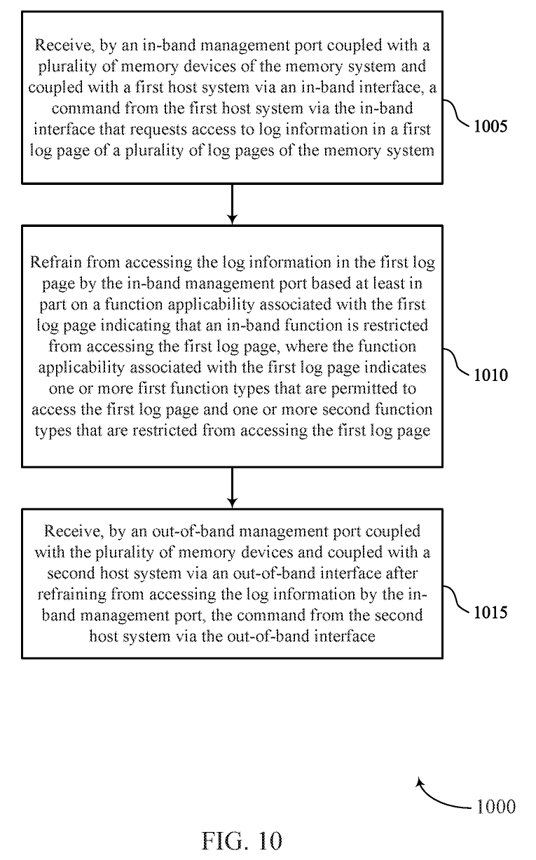

FIG. 7 shows a flowchart illustrating a method 700 that supports function applicability for determination of supported commands in accordance with examples as disclosed herein. The operations of method 700 may be implemented by a memory system or its components as described herein. For example, the operations of method 700 may be performed by a memory system as described with reference to FIGS. 1 - 6. In some examples, a memory system may execute a set of instructions to control the functional elements of the device to perform the described functions. Additionally, or alternatively, the memory system may perform aspects of the described functions using special-purpose hardware.

At 705, the method may include receiving, at a management port coupled with a plurality of memory devices of the memory system and coupled with a first host system via a first host interface, a command from the first host system via the first host interface. In some examples, aspects of the operations of 705 may be performed by a command component 625 as described with reference to FIG. 6.

At 710, the method may include determining a function applicability associated with the command based at least in part on a function applicability configuration for the memory system, the function applicability indicating one or more function types that are permitted to support execution of the command, the one or more function types including a virtual function, a physical function, or both. In some examples, aspects of the operations of 710 may be performed by a function applicability component 630 as described with reference to FIG. 6.

At 715, the method may include executing, based at least in part on the function applicability associated with the command and on whether the first host interface via which the command is received is an out-of-band interface or an in-band interface, the command using at least a first function of a set of functions of the management port. In some examples, aspects of the operations of 715 may be performed by an execution component 635 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving, at a management port coupled with a plurality of memory devices of the memory system and coupled with a first host system via a first host interface, a command from the first host system via the first host interface; determining a function applicability associated with the command based at least in part on a function applicability configuration for the memory system, the function applicability indicating one or more function types that are permitted to support execution of the command, the one or more function types including a virtual function, a physical function, or both; and executing, based at least in part on the function applicability associated with the command and on whether the first host interface via which the command is received is an out-of-band interface or an in-band interface, the command using at least a first function of a set of functions of the management port.
Aspect 2: The method, apparatus, or non-transitory computer-readable medium of aspect 1, where determining the function applicability associated with the command includes operations, features, circuitry, logic, means, or instructions, or any combination thereof for determining that the one or more function types that are permitted to support execution of the command include in-band functions, out-of-band functions, or both.
Aspect 3: The method, apparatus, or non-transitory computer-readable medium of any of aspects 1 through 2, where, determining the function applicability associated with the command includes operations, features, circuitry, logic, means, or instructions, or any combination thereof for determining that the one or more function types that are permitted to support execution of the command include virtual functions, physical functions, or both.
Aspect 4: The method, apparatus, or non-transitory computer-readable medium of any of aspects 1 through 3, where the function applicability configuration indicates a respective function applicability for each command of a plurality of commands supported by the management port.
Aspect 5: The method, apparatus, or non-transitory computer-readable medium of any of aspects 1 through 4, further including operations, features, circuitry, logic, means, or instructions, or any combination thereof for receiving, at the management port, a second command from the first host system via the first host interface and determining a second function applicability associated with the second command based at least in part on the function applicability configuration, where the second function applicability indicates one or more second function types that are permitted to support execution of the second command, the one or more second function types being different from the one or more function types associated with the function applicability of the command.
Aspect 6: The method, apparatus, or non-transitory computer-readable medium of aspect 5, where the one or more second function types associated with the second function applicability exclude out-of-band functions.
Aspect 7: The method, apparatus, or non-transitory computer-readable medium of any of aspects 5 through 6, further including operations, features, circuitry, logic, means, or instructions, or any combination thereof for refraining from executing the second command based at least in part on the second function applicability indicating that the one or more second function types that are permitted to support execution of the second command exclude out-of-band functions and based at least in part on the first host interface via which the second command is received being the out-of-band interface.
Aspect 8: The method, apparatus, or non-transitory computer-readable medium of any of aspects 1 through 7, where the out-of-band interface includes a system management bus.
Aspect 9: The method, apparatus, or non-transitory computer-readable medium of any of aspects 1 through 8, where the out-of-band interface includes a management interface configured to support one or more vendor defined messages.
Aspect 10: The method, apparatus, or non-transitory computer-readable medium of any of aspects 1 through 9, where the command includes an administrative command, a get or set feature command, a management interface command, or any combination thereof.
Aspect 11: The method, apparatus, or non-transitory computer-readable medium of any of aspects 1 through 10, where the management port is coupled with the first host system via the out-of-band interface and the method, apparatuses, and non-transitory computer-readable medium further includes operations, features, circuitry, logic, means, or instructions, or any combination thereof for receiving, at a second management port coupled with the plurality of memory devices and coupled with a second host system via a second interface that is the in-band interface, a plurality of second commands via the in-band interface and determining whether to execute the plurality of second commands based at least in part on respective function applicability information for the plurality of second commands.

FIG. 8 shows a flowchart illustrating a method 800 that supports function applicability for determination of supported commands in accordance with examples as disclosed herein. The operations of method 800 may be implemented by a memory system or its components as described herein. For example, the operations of method 800 may be performed by a memory system as described with reference to FIGS. 1 - 6. In some examples, a memory system may execute a set of instructions to control the functional elements of the device to perform the described functions. Additionally, or alternatively, the memory system may perform aspects of the described functions using special-purpose hardware.

At 805, the method may include receiving, by an out-of-band management port coupled with a plurality of memory devices of the memory system and coupled with a first host system via an out-of-band interface, a command from the first host system via the out-of-band interface. In some examples, aspects of the operations of 805 may be performed by a command component 625 as described with reference to FIG. 6.

At 810, the method may include refraining from executing the command by the out-of-band management port based at least in part on a function applicability associated with the command indicating that an out-of-band function is restricted from executing the command, where the function applicability associated with the command indicates one or more first function types that are permitted to support execution of the command and one or more second function types that are restricted from executing the command. In some examples, aspects of the operations of 810 may be performed by an execution component 635 as described with reference to FIG. 6.

At 815, the method may include receiving, by an in-band management port coupled with the plurality of memory devices and coupled with a second host system via an in-band interface after refraining from executing the command by the out-of-band management port, the command from the second host system via the in-band interface. In some examples, aspects of the operations of 815 may be performed by a command component 625 as described with reference to FIG. 6.

At 820, the method may include executing the command by the in-band management port using one or more functions of the in-band management port based at least in part on the function applicability associated with the command. In some examples, aspects of the operations of 820 may be performed by an execution component 635 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 12: A method, apparatus, or non-transitory computer-readable medium including operations, features, circuitry, logic, means, or instructions, or any combination thereof for receiving, by an out-of-band management port coupled with a plurality of memory devices of the memory system and coupled with a first host system via an out-of-band interface, a command from the first host system via the out-of-band interface; refraining from executing the command by the out-of-band management port based at least in part on a function applicability associated with the command indicating that an out-of-band function is restricted from executing the command, where the function applicability associated with the command indicates one or more first function types that are permitted to support execution of the command and one or more second function types that are restricted from executing the command; receiving, by an in-band management port coupled with the plurality of memory devices and coupled with a second host system via an in-band interface after refraining from executing the command by the out-of-band management port, the command from the second host system via the in-band interface; and executing the command by the in-band management port using one or more functions of the in-band management port based at least in part on the function applicability associated with the command.
Aspect 13: The method, apparatus, or non-transitory computer-readable medium of aspect 12, further including operations, features, circuitry, logic, means, or instructions, or any combination thereof for receiving, by the out-of-band management port, a management port configuration that indicates the in-band management port from a plurality of ports of the memory system and indicates a function applicability configuration for the memory system, where executing the command by the in-band management port is based at least in part on receiving the management port configuration.
Aspect 14: The method, apparatus, or non-transitory computer-readable medium of any of aspects 12 through 13, where the function applicability associated with the command is based at least in part on a function applicability configuration that indicates a respective function applicability for each command of a plurality of commands supported by the memory system.
Aspect 15: The method, apparatus, or non-transitory computer-readable medium of any of aspects 12 through 14, where the out-of-band interface includes a system management bus.
Aspect 16: The method, apparatus, or non-transitory computer-readable medium of any of aspects 12 through 15, where the out-of-band interface includes a management interface configured to support one or more vendor defined messages.
Aspect 17: The method, apparatus, or non-transitory computer-readable medium of any of aspects 12 through 16, where the command includes an administrative command, a get or set feature command, a management interface command, or any combination thereof.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 18: An apparatus, including: a plurality of memory devices; a plurality of ports coupled with the plurality of memory devices, each port of the plurality of ports coupled with a respective host system via a respective host interface; and a management port coupled with the plurality of memory devices and coupled with a first host system via a first host interface, where the management port is configured to: receive a command via the first host interface; determine a function applicability associated with the command based at least in part on a function applicability configuration for the apparatus, the function applicability indicating one or more function types that are permitted to support execution of the command, the one or more function types including a virtual function, a physical function, or both; and execute, based at least in part on the function applicability associated with the command and on whether the first host interface via which the command is received is an out-of-band interface or an in-band interface, the command using at least a first function of a set of functions of the management port.
Aspect 19: The apparatus of aspect 18, where, to determine the function applicability associated with the command, the management port is further configured to: determine that the one or more function types that are permitted to support execution of the command include in-band functions, out-of-band functions, or both.
Aspect 20: The apparatus of any of aspects 18 through 19, where, to determine the function applicability associated with the command, the management port is further configured to: determine that the one or more function types that are permitted to support execution of the command include virtual functions, physical functions, or both.
Aspect 21: The apparatus of any of aspects 18 through 20, where the function applicability configuration indicates a respective function applicability for each command of a plurality of commands supported by the management port.
Aspect 22: The apparatus of any of aspects 18 through 21, where the management port is further configured to: receive a second command from the first host system via the first host interface; and determine a second function applicability associated with the second command based at least in part on the function applicability configuration, where the second function applicability indicates one or more second function types that are permitted to support execution of the second command, the one or more second function types being different from the one or more function types associated with the function applicability of the command.
Aspect 23: The apparatus of aspect 22, where the one or more second function types associated with the second function applicability exclude out-of-band functions.
Aspect 24: The apparatus of any of aspects 22 through 23, where the management port is further configured to: refrain from executing the second command based at least in part on the second function applicability indicating that the one or more second function types that are permitted to support execution of the second command exclude out-of-band functions and based at least in part on the first host interface via which the second command is received being the out-of-band interface.
Aspect 25: The apparatus of any of aspects 18 through 24, where the out-of-band interface includes a system management bus.
Aspect 26: The apparatus of any of aspects 18 through 25, where the out-of-band interface includes a management interface configured to support one or more vendor defined messages.
Aspect 27: The apparatus of any of aspects 18 through 26, where the plurality of ports coupled with the plurality of memory devices are peripheral component interface (PCI) ports.
Aspect 28: The apparatus of any of aspects 18 through 27, where the command includes an administrative command, a get or set feature command, a management interface command, or any combination thereof.
Aspect 29: The apparatus of any of aspects 18 through 28, where the management port is coupled with the first host system via the out-of-band interface, and where the apparatus further includes: a second management port coupled with a second host system via a second interface that is an in-band interface, where the second management port is configured to: receive a plurality of second commands via the in-band interface; and determine whether to execute the plurality of second commands based at least in part on respective function applicability information for the plurality of second commands.

An apparatus is described. The following provides an overview of aspects of the apparatus as described herein:
Aspect 30: A memory system, including: a plurality of memory devices; a plurality of ports coupled with the plurality of memory devices, each port of the plurality of ports coupled with a respective host system via a respective in-band interface; an in-band management port coupled with the plurality of memory devices and coupled with a first host system via a first in-band interface; an out-of-band management port coupled with the plurality of memory devices and coupled with a second host system via an out-of-band interface; and processing circuitry coupled with the plurality of memory devices, the plurality of ports, the in-band management port, and the out-of-band management port, and configured to cause the memory system to: receive, by the out-of-band management port, a command via the out-of-band interface; refrain from executing the command by the out-of-band management port based at least in part on a function applicability associated with the command indicating that an out-of-band function is restricted from executing the command, the function applicability associated with the command indicates one or more first function types that are permitted to support execution of the command and one or more second function types that are restricted from executing the command; receive, by the in-band management port after refraining from executing the command by the out-of-band management port, the command via the first in-band interface; and execute the command by the in-band management port using one or more functions of the in-band management port based at least in part on the function applicability associated with the command.
Aspect 31: The memory system of aspect 30, where the processing circuitry is further configured to: receive, by the out-of-band management port, a management port configuration that indicates the in-band management port from the plurality of ports and indicates a function applicability configuration for the memory system, where executing the command by the in-band management port is based at least in part on receiving the management port configuration.
Aspect 32: The memory system of any of aspects 30 through 31, where the function applicability associated with the command is based at least in part on a function applicability configuration that indicates a respective function applicability for each command of a plurality of commands supported by the memory system.
Aspect 33: The memory system of any of aspects 30 through 32, where the out-of-band interface includes a system management bus.
Aspect 34: The memory system of any of aspects 30 through 33, where the out-of-band interface includes a management interface configured to support one or more vendor defined messages.
Aspect 35: The memory system of any of aspects 30 through 34, where the plurality of ports coupled with the plurality of memory devices are peripheral component interface (PCI) ports.
Aspect 36: The memory system of any of aspects 30 through 35, where the command includes an administrative command, a get or set feature command, a management interface command, or any combination thereof.

FIG. 9 shows a flowchart illustrating a method 900 that supports function applicability for determination of supported log pages in accordance with examples as disclosed herein. The operations of method 900 may be implemented by a memory system or its components as described herein. For example, the operations of method 900 may be performed by a memory system as described with reference to FIGS. 1 - 6. In some examples, a memory system may execute a set of instructions to control the functional elements of the device to perform the described functions. Additionally, or alternatively, the memory system may perform aspects of the described functions using special-purpose hardware.

At 905, the method may include receiving, by a management port coupled with a plurality of memory devices of the memory system and coupled with a first host system via a first host interface, a command from the first host system via the first host interface that requests access to log information in a first log page of a plurality of log pages of the memory system. In some examples, aspects of the operations of 905 may be performed by a command component 625 as described with reference to FIG. 6.

At 910, the method may include determining a function applicability associated with the first log page based at least in part on a function applicability configuration for the memory system, the function applicability indicating one or more function types that are permitted to support access to the log information, the one or more function types including a virtual function, a physical function, or both. In some examples, aspects of the operations of 910 may be performed by a function applicability component 630 as described with reference to FIG. 6.

At 915, the method may include accessing, based at least in part on the function applicability associated with the first log page and based at least in part on whether the first host interface via which the command is received is an out-of-band interface or an in-band interface, the log information from the first log page using at least a first function of a set of functions of the management port. In some examples, aspects of the operations of 915 may be performed by a log component 645 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:
Aspect 37: A method, apparatus, or non-transitory computer-readable medium including operations, features, circuitry, logic, means, or instructions, or any combination thereof for receiving, by a management port coupled with a plurality of memory devices of the memory system and coupled with a first host system via a first host interface, a command from the first host system via the first host interface that requests access to log information in a first log page of a plurality of log pages of the memory system; determining a function applicability associated with the first log page based at least in part on a function applicability configuration for the memory system, the function applicability indicating one or more function types that are permitted to support access to the log information, the one or more function types including a virtual function, a physical function, or both; and accessing, based at least in part on the function applicability associated with the first log page and based at least in part on whether the first host interface via which the command is received is an out-of-band interface or an in-band interface, the log information from the first log page using at least a first function of a set of functions of the management port.
Aspect 38: The method, apparatus, or non-transitory computer-readable medium of aspect 37, further including operations, features, circuitry, logic, means, or instructions, or any combination thereof for determining a controller scope associated with the first log page based at least in part on a controller scope configuration for the memory system, the controller scope indicating that the log information in the first log page corresponds to a first subset of controllers of the memory system, where access to the log information is further based at least in part on the controller scope associated with the first log page.
Aspect 39: The method, apparatus, or non-transitory computer-readable medium of aspect 38, where the controller scope configuration includes a namespace identifier indicating the controller scope associated with the first log page.
Aspect 40: The method, apparatus, or non-transitory computer-readable medium of any of aspects 37 through 39, where determining the function applicability associated with the first log page includes operations, features, circuitry, logic, means, or instructions, or any combination thereof for determining that the one or more function types that are permitted to support access to the log information in the first log page include in-band functions, out-of-band functions, or both.
Aspect 41: The method, apparatus, or non-transitory computer-readable medium of any of aspects 37 through 40, where determining the function applicability associated with the first log page includes operations, features, circuitry, logic, means, or instructions, or any combination thereof for determining that the one or more function types that are permitted to support access to the log information in the first log page include virtual functions, physical functions, or both.
Aspect 42: The method, apparatus, or non-transitory computer-readable medium of any of aspects 37 through 41, where the function applicability configuration indicates a respective function applicability and a respective controller scope for each log page of the plurality of log pages of the memory system.
Aspect 43: The method, apparatus, or non-transitory computer-readable medium of any of aspects 37 through 42, further including operations, features, circuitry, logic, means, or instructions, or any combination thereof for receiving, from the first host system via the first host interface, a second command that requests access to second log information in a second log page of the plurality of log pages of the memory system and determining a second function applicability associated with the second log page based at least in part on the function applicability configuration, where the second function applicability indicates one or more second function types that are permitted to support access of the second log page, the one or more second function types being different from the one or more function types associated with the function applicability of the first log page.
Aspect 44: The method, apparatus, or non-transitory computer-readable medium of aspect 43, where the one or more second function types associated with the second function applicability exclude virtual functions.
Aspect 45: The method, apparatus, or non-transitory computer-readable medium of any of aspects 43 through 44, further including operations, features, circuitry, logic, means, or instructions, or any combination thereof for refraining from accessing the second log information in the second log page based at least in part on the second function applicability indicating that the one or more second function types that are permitted to support access of the second log page exclude virtual functions and based at least in part on the second command being received via the virtual function.
Aspect 46: The method, apparatus, or non-transitory computer-readable medium of any of aspects 37 through 45, where the out-of-band interface includes a system management bus.
Aspect 47: The method, apparatus, or non-transitory computer-readable medium of any of aspects 37 through 46, where the out-of-band interface includes a management interface configured to support one or more vendor defined messages.
Aspect 48: The method, apparatus, or non-transitory computer-readable medium of any of aspects 37 through 47, where the management port is coupled with the first host system via the out-of-band interface and the method, apparatuses, and non-transitory computer-readable medium further includes operations, features, circuitry, logic, means, or instructions, or any combination thereof for receiving, by a second management port coupled with the plurality of memory devices and coupled with a second host system via a second interface that is the in-band interface, a plurality of second commands that request access to respective log information in a plurality of second log pages of the plurality of log pages of the memory system and determining whether to access the respective log information in each log page of the plurality of second log pages based at least in part on a respective function applicability for each log page of the plurality of second log pages.

FIG. 10 shows a flowchart illustrating a method 1000 that supports function applicability for determination of supported log pages in accordance with examples as disclosed herein. The operations of method 1000 may be implemented by a memory system or its components as described herein. For example, the operations of method 1000 may be performed by a memory system as described with reference to FIGS. 1 - 6. In some examples, a memory system may execute a set of instructions to control the functional elements of the device to perform the described functions. Additionally, or alternatively, the memory system may perform aspects of the described functions using special-purpose hardware.

At 1005, the method may include receiving, by an in-band management port coupled with a plurality of memory devices of the memory system and coupled with a first host system via an in-band interface, a command from the first host system via the in-band interface that requests access to log information in a first log page of a plurality of log pages of the memory system. In some examples, aspects of the operations of 1005 may be performed by a command component 625 as described with reference to FIG. 6.

At 1010, the method may include refraining from accessing the log information in the first log page by the in-band management port based at least in part on a function applicability associated with the first log page indicating that an in-band function is restricted from accessing the first log page, where the function applicability associated with the first log page indicates one or more first function types that are permitted to access the first log page and one or more second function types that are restricted from accessing the first log page. In some examples, aspects of the operations of 1010 may be performed by a log component 645 as described with reference to FIG. 6.

At 1015, the method may include receiving, by an out-of-band management port coupled with the plurality of memory devices and coupled with a second host system via an out-of-band interface after refraining from accessing the log information by the in-band management port, the command from the second host system via the out-of-band interface. In some examples, aspects of the operations of 1015 may be performed by a command component 625 as described with reference to FIG. 6.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:
Aspect 49: A method, apparatus, or non-transitory computer-readable medium including operations, features, circuitry, logic, means, or instructions, or any combination thereof for receiving, by an in-band management port coupled with a plurality of memory devices of the memory system and coupled with a first host system via an in-band interface, a command from the first host system via the in-band interface that requests access to log information in a first log page of a plurality of log pages of the memory system; refraining from accessing the log information in the first log page by the in-band management port based at least in part on a function applicability associated with the first log page indicating that an in-band function is restricted from accessing the first log page, where the function applicability associated with the first log page indicates one or more first function types that are permitted to access the first log page and one or more second function types that are restricted from accessing the first log page; and receiving, by an out-of-band management port coupled with the plurality of memory devices and coupled with a second host system via an out-of-band interface after refraining from accessing the log information by the in-band management port, the command from the second host system via the out-of-band interface.
Aspect 50: The method, apparatus, or non-transitory computer-readable medium of aspect 49, further including operations, features, circuitry, logic, means, or instructions, or any combination thereof for accessing, by the out-of-band management port, the log information at the first log page using one or more functions of the out-of-band management port based at least in part on the function applicability associated with the first log page and on the command being received via the out-of-band interface.
Aspect 51: The method, apparatus, or non-transitory computer-readable medium of any of aspects 49 through 50, where refraining from accessing the log information in the first log page by the in-band management port is further based at least in part on receiving the command via a virtual function and the function applicability associated with the first log page indicating that the virtual function is restricted from accessing the first log page.
Aspect 52: The method, apparatus, or non-transitory computer-readable medium of any of aspects 49 through 51, further including operations, features, circuitry, logic, means, or instructions, or any combination thereof for receiving, by the out-of-band management port, a management port configuration that indicates the in-band management port from a plurality of ports of the memory system and indicates a function applicability configuration for the memory system, where refraining from accessing the log information in the first log page by the in-band management port is based at least in part on receiving the management port configuration.
Aspect 53: The method, apparatus, or non-transitory computer-readable medium of any of aspects 49 through 52, where the function applicability associated with the first log page is based at least in part on a function applicability configuration that indicates a respective function applicability for each log page of the plurality of log pages of the memory system.
Aspect 54: The method, apparatus, or non-transitory computer-readable medium of any of aspects 49 through 53, where the out-of-band interface includes a system management bus.
Aspect 55: The method, apparatus, or non-transitory computer-readable medium of any of aspects 49 through 54, where the out-of-band interface includes a management interface configured to support one or more vendor defined messages.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 56: An apparatus, including: a plurality of memory devices; a plurality of ports coupled with the plurality of memory devices, each port of the plurality of ports coupled with a respective host system via a respective host interface; and a management port coupled with the plurality of memory devices and coupled with a first host system via a first host interface, where the management port is configured to: receive, via the first host interface, a command that requests access to log information in a first log page of a plurality of log pages of the apparatus; determine a function applicability associated with the first log page based at least in part on a function applicability configuration for the apparatus, the function applicability indicating one or more function types that are permitted to support access to the log information, the one or more function types including a virtual function, a physical function, or both; and access, based at least in part on the function applicability associated with the first log page and based at least in part on whether the first host interface via which the command is received is an out-of-band interface or an in-band interface, the log information from the first log page using at least a first function of a set of functions of the management port.
Aspect 57: The apparatus of aspect 56, where the management port is further configured to: determine a controller scope associated with the first log page based at least in part on a controller scope configuration for the apparatus, the controller scope indicating that the log information in the first log page corresponds to a first subset of controllers of the apparatus, where access to the log information is further based at least in part on the controller scope associated with the first log page.
Aspect 58: The apparatus of aspect 57, where the controller scope configuration includes a namespace identifier indicating the controller scope associated with the first log page.
Aspect 59: The apparatus of any of aspects 56 through 58, where, to determine the function applicability associated with the first log page, the management port is further configured to: determine that the one or more function types that are permitted to support access to the log information in the first log page include in-band functions, out-of-band functions, or both.
Aspect 60: The apparatus of any of aspects 56 through 59, where, to determine the function applicability associated with the first log page, the management port is further configured to: determine that the one or more function types that are permitted to support access to the log information in the first log page include virtual functions, physical functions, or both.
Aspect 61: The apparatus of any of aspects 56 through 60, where the function applicability configuration indicates a respective function applicability and a respective controller scope for each log page of the plurality of log pages of the apparatus.
Aspect 62: The apparatus of any of aspects 56 through 61, where the management port is further configured to: receive, from the first host system via the first host interface, a second command that requests access to second log information in a second log page of the plurality of log pages of the apparatus; and determine a second function applicability associated with the second log page based at least in part on the function applicability configuration, where the second function applicability indicates one or more second function types that are permitted to support access of the second log page, the one or more second function types being different from the one or more function types associated with the function applicability of the first log page.
Aspect 63: The apparatus of aspect 62, where the one or more second function types associated with the second function applicability exclude virtual functions.
Aspect 64: The apparatus of any of aspects 62 through 63, where the management port is further configured to: refrain from accessing the second log information in the second log page based at least in part on the second function applicability indicating that the one or more second function types that are permitted to support access of the second log page exclude virtual functions and based at least in part on the second command being received via the virtual function.
Aspect 65: The apparatus of any of aspects 56 through 64, where the out-of-band interface includes a system management bus.
Aspect 66: The apparatus of any of aspects 56 through 65, where the out-of-band interface includes a management interface configured to support one or more vendor defined messages.
Aspect 67: The apparatus of any of aspects 56 through 66, where the plurality of ports coupled with the plurality of memory devices are peripheral component interface (PCI) ports.
Aspect 68: The apparatus of any of aspects 56 through 67, where the management port is coupled with the first host system via the out-of-band interface, and where the apparatus further includes: a second management port coupled with a second host system via a second interface that is an in-band interface, where the second management port is configured to: receive, via the in-band interface, a plurality of second commands that request access to respective log information in a plurality of second log pages of the plurality of log pages of the apparatus; and determine whether to access the respective log information in each log page of the plurality of second log pages based at least in part on a respective function applicability for each log page of the plurality of second log pages.

An apparatus is described. The following provides an overview of aspects of the apparatus as described herein:
Aspect 69: A memory system, including: a plurality of memory devices; a plurality of ports coupled with the plurality of memory devices, each port of the plurality of ports coupled with a respective host system via a respective in-band interface; an in-band management port coupled with the plurality of memory devices and coupled with a first host system via a first in-band interface; an out-of-band management port coupled with the plurality of memory devices and coupled with a second host system via an out-of-band interface; and processing circuitry coupled with the plurality of memory devices, the plurality of ports, the in-band management port, and the out-of-band management port, and configured to cause the memory system to: receive, by the in-band management port and via the first in-band interface, a command that requests access to log information in a first log page of a plurality of log pages of the memory system; refrain from accessing the log information in the first log page by the in-band management port based at least in part on a function applicability associated with the first log page indicating that an in-band function is restricted from accessing the first log page, where the function applicability associated with the first log page indicates one or more first function types that are permitted to access the first log page and one or more second function types that are restricted from accessing the first log page; and receive, by the out-of-band management port after refraining from accessing the log information by the in-band management port, the command via the out-of-band interface.
Aspect 70: The memory system of aspect 69, where the processing circuitry is further configured to: access, by the out-of-band management port, the log information at the first log page using one or more functions of the out-of-band management port based at least in part on the function applicability associated with the first log page and on the command being received via the out-of-band interface.
Aspect 71: The memory system of any of aspects 69 through 70, where refraining from accessing the log information in the first log page by the in-band management port is further based at least in part on receiving the command via a virtual function and the function applicability associated with the first log page indicating that the virtual function is restricted from accessing the first log page.
Aspect 72: The memory system of any of aspects 69 through 71, where the processing circuitry is further configured to: receive, by the out-of-band management port, a management port configuration that indicates the in-band management port from the plurality of ports and indicates a function applicability configuration for the memory system, where refraining from accessing the log information in the first log page by the in-band management port is based at least in part on receiving the management port configuration.
Aspect 73: The memory system of any of aspects 69 through 72, where the function applicability associated with the first log page is based at least in part on a function applicability configuration that indicates a respective function applicability for each log page of the plurality of log pages of the memory system.
Aspect 74: The memory system of any of aspects 69 through 73, where the out-of-band interface includes a system management bus.
Aspect 75: The memory system of any of aspects 69 through 74, where the out-of-band interface includes a management interface configured to support one or more vendor defined messages.
Aspect 76: The memory system of any of aspects 69 through 75, where the plurality of ports coupled with the plurality of memory devices are peripheral component interface (PCI) ports.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., any combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a plurality of memory devices;
a plurality of ports coupled with the plurality of memory devices, each port of the plurality of ports coupled with a respective host system via a respective host interface; and
a management port coupled with the plurality of memory devices and coupled with a first host system via a first host interface, wherein the management port is configured to:
receive a command via the first host interface;
determine a function applicability associated with the command based at least in part on a function applicability configuration for the apparatus, the function applicability indicating one or more function types that are permitted to support execution of the command, the one or more function types comprising a virtual function, a physical function, or both; and
execute, based at least in part on the function applicability associated with the command and on whether the first host interface via which the command is received is an out-of-band interface or an in-band interface, the command using at least a first function of a set of functions of the management port.

2. The apparatus of claim 1, wherein, to determine the function applicability associated with the command, the management port is further configured to:
determine that the one or more function types that are permitted to support execution of the command include in-band functions, out-of-band functions, or both.

3. The apparatus of claim 1, wherein, to determine the function applicability associated with the command, the management port is further configured to:
determine that the one or more function types that are permitted to support execution of the command include virtual functions, physical functions, or both.

4. The apparatus of claim 1, wherein the function applicability configuration indicates a respective function applicability for each command of a plurality of commands supported by the management port.

5. The apparatus of claim 1, wherein the management port is further configured to:
receive a second command from the first host system via the first host interface; and
determine a second function applicability associated with the second command based at least in part on the function applicability configuration, wherein the second function applicability indicates one or more second function types that are permitted to support execution of the second command, the one or more second function types being different from the one or more function types associated with the function applicability of the command.

6. The apparatus of claim 5, wherein the one or more second function types associated with the second function applicability exclude out-of-band functions.

7. The apparatus of claim 5, wherein the management port is further configured to:
refrain from executing the second command based at least in part on the second function applicability indicating that the one or more second function types that are permitted to support execution of the second command exclude out-of-band functions and based at least in part on the first host interface via which the second command is received being the out-of-band interface.

8. The apparatus of claim 1, wherein the out-of-band interface comprises a system management bus.

9. The apparatus of claim 1, wherein the out-of-band interface comprises a management interface configured to support one or more vendor defined messages.

10. The apparatus of claim 1, wherein the plurality of ports coupled with the plurality of memory devices are peripheral component interface (PCI) ports.

11. The apparatus of claim 1, wherein the command comprises an administrative command, a get or set feature command, a management interface command, or any combination thereof.

12. The apparatus of claim 1, wherein the management port is coupled with the first host system via the out-of-band interface, and wherein the apparatus further comprises:
a second management port coupled with a second host system via a second interface that is an in-band interface, wherein the second management port is configured to:
receive a plurality of second commands via the in-band interface; and
determine whether to execute the plurality of second commands based at least in part on respective function applicability information for the plurality of second commands.

13. A memory system, comprising:
a plurality of memory devices;
a plurality of ports coupled with the plurality of memory devices, each port of the plurality of ports coupled with a respective host system via a respective in-band interface;
an in-band management port coupled with the plurality of memory devices and coupled with a first host system via a first in-band interface;
an out-of-band management port coupled with the plurality of memory devices and coupled with a second host system via an out-of-band interface; and
processing circuitry coupled with the plurality of memory devices, the plurality of ports, the in-band management port, and the out-of-band management port, and configured to cause the memory system to:
receive, by the out-of-band management port, a command via the out-of-band interface;
refrain from executing the command by the out-of-band management port based at least in part on a function applicability associated with the command indicating that an out-of-band function is restricted from executing the command, the function applicability associated with the command indicates one or more first function types that are permitted to support execution of the command and one or more second function types that are restricted from executing the command;
receive, by the in-band management port after refraining from executing the command by the out-of-band management port, the command via the first in-band interface; and
execute the command by the in-band management port using one or more functions of the in-band management port based at least in part on the function applicability associated with the command.

14. The memory system of claim 13, wherein the processing circuitry is further configured to:
receive, by the out-of-band management port, a management port configuration that indicates the in-band management port from the plurality of ports and indicates a function applicability configuration for the memory system, wherein executing the command by the in-band management port is based at least in part on receiving the management port configuration.

15. The memory system of claim 13, wherein the function applicability associated with the command is based at least in part on a function applicability configuration that indicates a respective function applicability for each command of a plurality of commands supported by the memory system.

16. The memory system of claim 13, wherein the out-of-band interface comprises a system management bus.

17. The memory system of claim 13, wherein the out-of-band interface comprises a management interface configured to support one or more vendor defined messages.

18. The memory system of claim 13, wherein the plurality of ports coupled with the plurality of memory devices are peripheral component interface (PCI) ports.

19. The memory system of claim 13, wherein the command comprises an administrative command, a get or set feature command, a management interface command, or any combination thereof.

20. A method by a memory system, comprising:
receiving, at a management port coupled with a plurality of memory devices of the memory system and coupled with a first host system via a first host interface, a command from the first host system via the first host interface;
determining a function applicability associated with the command based at least in part on a function applicability configuration for the memory system, the function applicability indicating one or more function types that are permitted to support execution of the command, the one or more function types comprising a virtual function, a physical function, or both; and
executing, based at least in part on the function applicability associated with the command and on whether the first host interface via which the command is received is an out-of-band interface or an in-band interface, the command using at least a first function of a set of functions of the management port.

21. The method of claim 20, wherein determining the function applicability associated with the command comprises:
determining that the one or more function types that are permitted to support execution of the command include in-band functions, out-of-band functions, or both.

22. The method of claim 20, wherein, determining the function applicability associated with the command comprises:
determining that the one or more function types that are permitted to support execution of the command include virtual functions, physical functions, or both.

23. The method of claim 20, wherein the function applicability configuration indicates a respective function applicability for each command of a plurality of commands supported by the management port.

24. The method of claim 20, further comprising:
receiving, at the management port, a second command from the first host system via the first host interface; and
determining a second function applicability associated with the second command based at least in part on the function applicability configuration, wherein the second function applicability indicates one or more second function types that are permitted to support execution of the second command, the one or more second function types being different from the one or more function types associated with the function applicability of the command.

25. The method of claim 24, wherein the one or more second function types associated with the second function applicability exclude out-of-band functions.

26. The method of claim 24, further comprising:
refraining from executing the second command based at least in part on the second function applicability indicating that the one or more second function types that are permitted to support execution of the second command exclude out-of-band functions and based at least in part on the first host interface via which the second command is received being the out-of-band interface.

27. The method of claim 20, wherein the management port is coupled with the first host system via the out-of-band interface, the method further comprising:
receiving, at a second management port coupled with the plurality of memory devices and coupled with a second host system via a second interface that is the in-band interface, a plurality of second commands via the in-band interface; and
determining whether to execute the plurality of second commands based at least in part on respective function applicability information for the plurality of second commands.

28. A method by a memory system, comprising:
receiving, by an out-of-band management port coupled with a plurality of memory devices of the memory system and coupled with a first host system via an out-of-band interface, a command from the first host system via the out-of-band interface;
refraining from executing the command by the out-of-band management port based at least in part on a function applicability associated with the command indicating that an out-of-band function is restricted from executing the command, wherein the function applicability associated with the command indicates one or more first function types that are permitted to support execution of the command and one or more second function types that are restricted from executing the command;
receiving, by an in-band management port coupled with the plurality of memory devices and coupled with a second host system via an in-band interface after refraining from executing the command by the out-of-band management port, the command from the second host system via the in-band interface; and
executing the command by the in-band management port using one or more functions of the in-band management port based at least in part on the function applicability associated with the command.

29. The method of claim 28, further comprising:
receiving, by the out-of-band management port, a management port configuration that indicates the in-band management port from a plurality of ports of the memory system and indicates a function applicability configuration for the memory system, wherein executing the command by the in-band management port is based at least in part on receiving the management port configuration.

30. A non-transitory computer-readable medium storing code, the code comprising instructions executable by one or more processors to:
receive, at a management port coupled with a plurality of memory devices of a memory system and coupled with a first host system via a first host interface, a command from the first host system via the first host interface;
determine a function applicability associated with the command based at least in part on a function applicability configuration for the memory system, the function applicability indicating one or more function types that are permitted to support execution of the command, the one or more function types comprising a virtual function, a physical function, or both; and
execute, based at least in part on the function applicability associated with the command and on whether the first host interface via which the command is received is an out-of-band interface or an in-band interface, the command using at least a first function of a set of functions of the management port.
